(19) United States
(12) Patent Application Publication
(10) Pub. No.: US 2025/0111747 A1
(43) Pub. Date: Apr. 3, 2025

(54) CASINO PAYMENT SYSTEM AND METHOD WITH INTEROPERABILITY IN CASINO ENVIRONMENTS

(71) Applicant: Aristocrat Technologies, Inc., Las Vegas, NV (US)

(72) Inventors: Cheyne Cole, Las Vegas, NV (US); Andrew Wyllie, North Ryde (AU); David Pickering, Peakhurst (AU); Alan Wong, West Pennant Hills (AU); Pankaj Bhandari, Mississauga (CA); Santosh Singh, Las Vegas, NV (US)

(21) Appl. No.: 18/894,559

(22) Filed: Sep. 24, 2024

Related U.S. Application Data
(60) Provisional application No. 63/586,376, filed on Sep. 28, 2023.

(51) Int. Cl. G07F 17/32; G06Q 20/36; G06Q 50/34

(52) U.S. Cl. CPC G07F 17/3244; G06Q 20/36; G06Q 50/34; G07F 17/3237

(57) ABSTRACT

A system is provided. The system may include a memory device and a processor configured to (1) determine a session has been established by a user at a gaming device associated with a CMS; (2) receive a transaction request associated with a gaming device, the transaction request identifying a transaction amount; (3) in response to determining the session has been established and receiving the transaction request, transmit instructions to cause an immutable CL to record a virtual transfer of funds record equal to the transaction amount from a virtual user account associated with the user to a venue virtual account; and (4) transmit instructions to a venue system to cause the CMS to initiate a transfer of the transaction amount from the venue gaming account to a credit balance of the gaming device.

### CROSS-REFERENCE TO RELATED APPLICATIONS

This application claims the benefit of priority of U.S. Provisional Application No. 63/586,376, filed Sep. 28, 2023, and entitled “CASINO PAYMENT SYSTEM AND METHOD WITH INTEROPERABILITY IN CASINO ENVIRONMENTS,” the contents and disclosures of which are hereby incorporated herein by reference in their entirety.

### TECHNICAL FIELD

The field of this disclosure relates generally to electronic gaming, and more specifically, to funding technology that provides for players to seamlessly transition from one gaming ecosystem to another gaming ecosystem.

### BACKGROUND

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

Some known gaming devices may also use historical horse racing results (e.g., or other historical data) to determine wagering game outcomes. In some known systems, it may be desired and/or required for at least a portion of a historical event associated with the historical data to be displayed. Thus, according to some known systems, if a display device configured to display a historical event malfunctions or is otherwise inoperable, a gaming device associated with that display device may be required to shut down until that display device is fixed or replaced (e.g., because until the display device is fixed, the historical event(s) desired/required to be displayed as part of an electronic game will not be displayed). Accordingly, systems and methods are desired for dynamic monitor detection in electronic gaming such that if an initial display device becomes inoperable, data is automatically displayed on a different display device instead of requiring a shut down of the gaming device until the initial display device is fixed and/or replaced.

### BRIEF DESCRIPTION

In one aspect, a computer system is provided. The computer system may include at least one processor in communication with at least one memory device, with a casino management system (CMS) that is associated with a venue gaming account, and with an immutable CL that is associated with a system account that stores actual funds. The immutable CL may include a venue virtual account and multiple virtual user accounts for a stored value account of a user. The least one processor may be configured to execute instructions which, when executed by the at least one processor, cause the at least one processor to: (1) determine a session has been established by the user at a gaming device associated with the CMS; (2) receive a transaction request associated with the gaming device, the transaction request identifying a transaction amount; (3) in response to determining the session has been established and receiving the transaction request, transmit instructions to the immutable CL to cause the immutable CL to record a virtual transfer of funds record equal to the transaction amount from a virtual user account associated with the user to the venue virtual account; and (4) in response to receiving a first confirmation from the immutable CL that the virtual transfer of funds record is recorded, transmit instructions to a venue system to cause the CMS to initiate a transfer of the transaction amount from the venue gaming account to a credit balance of the gaming device.

In another aspect, a method is provided. The method may be performed by at least one processor in communication with at least one memory device, with a casino management system (CMS) that is associated with a venue gaming account, and with an immutable CL that is associated with a system account that stores actual funds. The immutable CL may include a venue virtual account and multiple virtual user accounts for a stored value account of a user. The method may include (1) determining a session has been established by the users at a gaming device associated with the CMS; (2) receiving a transaction request associated with the gaming device, the transaction request identifying a transaction amount; (3) in response to determining the session has been established and receiving the transaction request, transmitting instructions to the immutable CL to cause the immutable CL to record a virtual transfer of funds record equal to the transaction amount from a virtual user account associated with the user to the venue virtual account; and (4) in response to receiving a first confirmation from the immutable CL that the virtual transfer of funds record is recorded, transmitting instructions to a venue system to cause the CMS to initiate a transfer of the transaction amount from the venue gaming account to a credit balance of the gaming device.

In another aspect, at least one non-transitory computer-readable storage media having instructions embodied thereon is provided. When executed by at least one processor in communication with at least one memory device, with a casino management system (CMS) that is associated with a venue gaming account, and with an immutable CL that is associated with a system account that stores actual funds, the immutable CL including a venue virtual account and multiple virtual user accounts for a stored value account of a user, the instructions may cause the at least one processor to: (1) determine a session has been established by the user at a gaming device associated with the CMS; (2) receive a transaction request associated with the gaming device, the transaction request identifying a transaction amount; (3) in response to determining the session has been established and receiving the transaction request, transmit instructions to the immutable CL to cause the immutable CL to record a virtual transfer of funds record equal to the transaction amount from a virtual user account associated with the user to the venue virtual account; and (4) in response to receiving a first confirmation from the immutable CL that the virtual transfer of funds record is recorded, transmit instructions to a venue system to cause the CMS to initiate a transfer of the transaction amount from the venue gaming account to a credit balance of the gaming device.

In another aspect, a system is provided. The system may include at least one proxy board configured to communicate with a gaming device. The system may further include at least one memory device configured to store a central ledger, the central ledger defining a plurality of accounts within a single centralized account, the plurality of accounts associated with a plurality of users and a plurality of locations. The system may further include at least one processor configured to execute instructions which, when executed by the at least one processor, may cause the at least one processor to (a) receive a transaction request associated with the gaming device from the at least one proxy board, the transaction request identifying (i) a user of the plurality of users, (ii) a location of the plurality of locations, and (iii) a transaction amount; (b) record the transaction request in the central ledger; (c) transmit, to the at least one proxy board, instructions to cause the gaming device to load the transaction amount to a credit balance of the gaming device; (d) determine, for the location, an aggregate transaction amount based on each transaction request recorded in the central ledger that is associated with the location for a predefined time period; and (e) transfer, from the single centralized account to an external account associated with the location, the aggregate transaction amount associated with the location.

### BRIEF DESCRIPTION OF THE DRAWINGS

FIG. 1 illustrates several different models of electronic gaming machines (EGMs) which maybe be networked to various gaming related servers in an exemplary embodiment.

FIG. 2A is a block diagram depicting various functional elements of an EGM in an exemplary embodiment.

FIG. 2B depicts a casino gaming environment in an exemplary embodiment.

FIG. 3 is a diagram of components of a system for providing online gaming in an example embodiment.

FIG. 4A is a block diagram that illustrates an overview of certain exemplary components and services of a gaming system including a universal payment system according to an exemplary embodiment of the present disclosure.

FIG. 4B is a continuation of the block diagram shown in FIG. 4A

FIG. 5 is a block diagram illustrating exemplary functional and/or logical operations of the universal payment system shown in FIGS. 4A and 4B.

FIG. 6 is a block diagram of an exemplary centralized ledger system of the universal payment system according to an exemplary embodiment of the present disclosure.

FIG. 7 is a flowchart illustrating an exemplary method for transferring funds to a gaming device using the universal payment system shown in FIGS. 4A and 4B.

FIG. 8 is a flowchart illustrating an exemplary method for off-site payment card transaction using the universal payment system shown in FIGS. 4A and 4B.

FIG. 9 illustrates an example overview of certain exemplary components and services of a gaming system including a universal payment system according to an exemplary embodiment of the present disclosure.

FIG. 10 is a block diagram illustrating exemplary components of the gaming system shown in FIG. 9 that are executed when a user associated with a universal digital wallet starts a session using a physical card at the gaming device according to an exemplary embodiment of the present disclosure.

FIG. 11 is a block diagram illustrating exemplary components of the gaming system shown in FIG. 9 that are executed when a user associated with a universal digital wallet starts a session using a mobile application at the gaming device according to an exemplary embodiment of the present disclosure.

FIG. 12 is a block diagram illustrating exemplary components of the gaming system shown in FIG. 9 that are executed when a user enters an amount to transfer via a mobile application at the gaming device according to an exemplary embodiment of the present disclosure.

FIG. 13 is a block diagram illustrating exemplary components of the gaming system shown in FIG. 9 that are executed when a session is ended by the user removing a card from the gaming device according to an exemplary embodiment of the present disclosure.

FIG. 14 is a block diagram illustrating exemplary components of the gaming system shown in FIG. 9 that are executed when a session is ended using a mobile application at the gaming device according to an exemplary embodiment of the present disclosure.

FIG. 15 is a flowchart illustrating an exemplary method for transferring funds to a gaming device using the system shown in FIG. 9.

FIG. 16 is a block diagram illustrating additional exemplary components and services of the universal payment system shown in FIG. 9 according to an exemplary embodiment of the present disclosure.

FIG. 17 is a flowchart illustrating an example responsible gaming (RG) check operation when connecting to a gaming device according to an exemplary embodiment of the present disclosure.

FIG. 18A depicts a flowchart illustrating an example funds transfer operation when connecting to a gaming device according to an exemplary embodiment of the present disclosure.

FIG. 18B is a continuation of the flowchart shown in FIG. 18A.

FIG. 18C is a continuation of the flowcharts shown in FIGS. 18A and 18B.

FIG. 19 is a data flow diagram illustrating an example data flow during a user enrollment process according to an exemplary embodiment of the present disclosure.

FIG. 20 is a flowchart illustrating an exemplary method for global player management using the system shown in FIG. 9.

### DETAILED DESCRIPTION

Casino digital systems often manage payments, payouts to users (e.g., players on an EGM, mobile device, digital gaming table, or other gaming device), and other financial transactions associated with gaming. These known digital systems are generally fragmented, with each manufacturer implementing different proprietary protocols and proprietary payments systems for casino transactions that do not communicate with each other. For example, in markets where casino enterprise properties are within proximity of each other, today's digital wallet architectures require cash balances (e.g., casino wagering accounts) to remain at each casino site/property. In other words, if that same user has a balance at one casino location and travels to another casino site, the user will have to first log back into the first casino site to transfer money to an external funding provider. For example, if a user transfers funds to casino A, leaves casino A, and heads over next door to casino B, the user will need to manually transfer funds from casino A to an external funding provider. After moving the funds, the user then transfers the balance from the external funding provider into a casino wagering account associated with the new property that the user wants to fund gameplay. Such movement of funds is time consuming, confusing, frustrating, and a waste of computational resources for both users and casino operators. Similarly, user tracking data, such as the data used for responsible gaming (RG) limits, is generally not transferred from one casino to another. Thus, there is a need to allow for a more seamless user experience where the patron's wallet balance and playing activity are easily accessible across multiple properties, enterprises, and/or jurisdictions while complying with regulations.

The fragmentation of today's casino payment system arises from implementing such known payment systems through existing casino management systems (CMSs). Typically, CMSs are proprietary systems that do not communicate with different proprietary CMSs, and therefore, are incompatible with each other. When implementing a cashless payment system, a casino operators generally chooses its existing proprietary CMS rather than adding or switching to other proprietary CMSs. Because some casinos might have different casino management and cashless payment systems, a user needs to open a different cashless gaming account at each casino. As a result, having a cashless payment system that is part of and dependent on CMS creates, a technical problem where casinos with different cashless payment systems are unable to transfer funds between each other. For example, if a user has a first venue gaming account with Casino Operator A that uses cashless payment system A, a second venue gaming account with Casino Operator B that uses a different cashless payment system B, and a third venue gaming account with Casino Operator C that uses a different cashless payment system C, the user may need a separate mobile wallet application to access funds in each venue gaming account for Casino Operators A, B, and C. The user must then access each venue gaming account using a separate mobile wallet and/or application to move funds rather than a single wallet application that can communicate with each casino management and cashless payment system.

In the embodiments described herein, a universal payment system (UPS) is configured to track and facilitate gaming and non-gaming transactions across multiple gaming venues and/or gaming ecosystems. Specifically, the UPS manages a for benefit of (FBO) account or some other custodial financial account that stores actual funds on behalf of a user or users and/or an entity or entities (generally referred throughout the disclosure as a “system account”). As described herein, through the UPS, a user can access actual funds deposited in the system account at multiple gaming properties and/or gaming environments. The UPS may transfer actual funds to the system account from an external financial funding source, such as a banking account at designated time frames.

The UPS includes an immutable central ledger (CL), which may also be referenced within this disclosure as an intermittent ledger or master ledger, to track transactions account across various gaming sessions, users, jurisdictions, and/or venue after a user's deposits actual funds into the system account. Specifically, to track and manage a user's funds, the immutable CL creates a stored-value account, which can also be referenced as a primary account, and one or more lower-level virtual user accounts (or “sub-accounts”) for a user to track non-gaming transactions and gaming transactions, such as transactions across a variety of casino games including EGMs, tables, and bar top games. In other words, the immutable CL creates an account structure with the top-level virtual user account being the primary account. The account structure links the top-level virtual user account (i.e., primary account) with multiple lower level virtual user accounts, such as virtual location accounts. The virtual location accounts may include a name of the casino where the gaming device at issue is located and/or the jurisdiction (e.g., state) where the casino at issue is located, etc. No actual funds are stored in this primary account. As described in further detail below, when a user transfers funds to a casino, a debit transaction is posted the user's stored value account and a credit transaction is posted for a virtual account associated with the casino. The inverse would happen when a player transfers funds from the casino.

When the UPS receives a user's request to fund gaming activity, the UPS computes an updated account balance tracked in the one or more virtual user accounts in the immutable CL, authorizes the gaming activity, and provides virtual funds to the gaming ecosystem (e.g., the casino's cashless wagering account). In the example embodiment, the UPS does not transfer actual funds from the system account during the authorization of gaming activity, and instead creates an entry in the immutable CL associated with the virtual user account(s) that identifies the transaction and amount for the gaming activity. Because the UPS does not transfer actual funds in response to the request, the user may not incur fees that are typically associated with each fund transfer. Further, because fewer transfers need to be made by the UPS, the data processing and transfer burden placed on the computer infrastructure is greatly lessened.

The lower-level virtual accounts that are tied to the primary account provide an audit trail for regulators that identifies where a user has spent his or her money. As an example, the immutable CL may state that player A has spent a total of $1,000. The primary account by itself may not necessarily identify where the money was spent. If a regulator wanted to know where the $1,000 was spent at, immutable CL may track this through the sub-accounts. For example, a separate sub-account can be created for each state to track spending in different states. Separate sub-accounts can also be created to track money spent in different casino locations within a given state or jurisdiction. Thus, having separate virtual accounts associated with a player's primary account can accurately track money and prevent activities such as money laundering.

At the end of the day, a reconciliation process occurs where the immutable CL is compared to the CMS record that track deposits and withdraws from the casino wagering accounts at the casino. This CMS record may be stored locally the casino. If the records stored in the immutable CL match the casino records, the UPS may then perform a payment settlement that transfers actual funds between (e.g., to or from) the system account and the casino's bank account or some other financial account that holds actual funds for the casino. This payment settlement transaction may be recorded in the master ledger under the casino's primary account. Because the UPS updates, reconciles, and settles all of the ledger transactions saved in an operator's primary account and/or virtual account(s) and transfers actual funds to and/or from the system account based on the settlement calculations, the overall number of actual fund transfers needed between the system account and casino financial accounts may be reduced.

As used herein an “actual funds transfer” refers to a transfer of funds between separate financial accounts (e.g., a bank account) involving a withdrawal of funds from a first financial account and a deposit of funds into another financial account.

As used herein a “virtual funds transfer” refers to a creation of a data entry (e.g., a ledger or accounting entry) defining an allocation of funds within a financial account without a transfer of funds into or out of the financial account.

As used herein, a “venue gaming account” refers to a financial account that is managed and tracked by a casino location and is separate from an immutable CL. An example of a venue gaming account is a cashless wagering account managed locally at a casino property with a CMS.

As used herein, a “user virtual account” is a virtual account associated with a user that does not store actual funds and is defined by one or more records within an immutable CL.

As used herein, a “venue virtual account” is a virtual account associated with a venue that does not store actual funds and is defined by one or more records within an immutable CL.

As described herein, an actual funds transfer may generally be described as a series of payment instruction messages, beginning with the originator's (sending customer's) instructions, and including a series of further instructions between the participating institutions, with the purpose of making actual payment to the beneficiary (receiving customer). In contrast, a virtual funds transfer may generally be described as a recording within a ledger of funds being virtually moved from one account to another account in the immutable CL. For example, a recording of debits and credits within accounts tracked in the immutable CL to represent the movement of funds between such accounts.

The UPS may further handle non-gaming transactions and/or transactions offsite from a casino, in which the UPS may function as a real-time debit payment system. The immutable CL will track both non-gaming and gaming transactions with virtual user account (s). Thus, the UPS minimizes the transactions fees for gaming transactions while allowing for the traditional/financial guard rails to continue to operate and be of use. In today's casino world, cashless payment systems incorporating real-time non-gaming transactions are not possible given that most casino-based, cashless payment systems are generally built to address gaming regulation requirements. In other words, the UPS satisfies gaming regulation requirements while maintaining the link between commercial point-of-sale (POS) systems and the system account.

The exemplary embodiments described herein may further include a digital wallet system that utilizes a wallet service broker that provides virtual fund transfer orchestration for a UPS. In these exemplary embodiments, a wallet service broker may be configured to include a transfer orchestrator that performs a variety of API calls to interface and manage a variety of independent systems. The transfer orchestrator may interface with the immutable CL that tracks virtual funds moved between user virtual accounts to venue virtual accounts. In one embodiment, the immutable CL may be managed and stored off-premise and/or externally to the casino venue system. The casino venue system may also include a CMS and other gaming application services. The transfer orchestrator may also manage fund requests and/or instructions originating from a mobile app on a mobile device. After receiving a fund transfer request from the mobile app, the transfer orchestrator may be configured to interface and communicate with a CMS or other venue wallet system to initiate the transfer of virtual funds from the user virtual account to the venue gaming account From the venue wallet, the transfer orchestrator may facilitate the transfer of virtual funds from the venue wallet to the gaming device via a gaming device interface (e.g., player tracking device, NFC connection, and/or Bluetooth connection). For every API call initiated by the transfer orchestrator, the wallet service broker may store each API within a wallet database to detect and resolve failures.

The exemplary embodiments described herein may further include an improved UPS that includes an off-premise, global player management system that may capture user data across multiple venues. With this UPS system, the venues do not need to belong to the same enterprise and, in fact, can be associated with different enterprises (e.g., venues associated with different operators).

In these exemplary embodiments, the UPS may include a global player management services system to capture user data over multiple venues. The global player management services may map a single player database record to multiple venue database records. By doing so, the global player management services can generate session summary information for a single user over multiple venues to determine whether a user has breached responsible gaming limits. As an example, the responsible gaming limits may be user-defined responsible gaming limits (e.g., amount spent or length of play). To map a single player database record to multiple venues, the global player management services may link a user's top-level virtual account stored in the system account to different player loyalty identifiers/account across multiple venues. The global player management services can be configured to have a single player database record within a certain country or other jurisdictional boundaries.

The system described herein may provide one or more of the following technical benefits: (1) reducing a number of data transfer operations and overall computational bandwidth needed to implement a digital wallet system by reducing a number of actual funds transfers needed to implement the digital wallet system by using an immutable CL to record at least some of the transactions as virtual funds transfers within the immutable CL rather than an actual funds transfer between separate external accounts; (2) improving computing efficiency of a computer system that provides a digital wallet system by reducing a number of actual funds transfers needed to implement the digital wallet system by using an immutable CL to record at least some of the transactions as virtual funds transfers within the immutable CL rather than an actual funds transfer between separate external accounts; (3) enabling presentation of multiple virtual wallet accounts of a user associated with separate venues as a single virtual wallet account associated with the user by providing an orchestrator that immutably records virtual funds transfers between one or more virtual accounts associated with the user and virtual accounts associated with the venues in an immutable CL; (4) providing a UPS that integrates separate, independent, and/or incompatible CMSs and associated payment systems by recording gaming transactions within an immutable CL and transferring funds between venue gaming accounts and a system account based on records stored in the immutable CL; and (5) enabling a local venue system to enforce RG limits based on player activity across multiple venues that do not share compatible player tracking systems or use different data formats for tracking player activity using a global player management system that retrieves player activity from and distributes player activity to multiple venue systems.

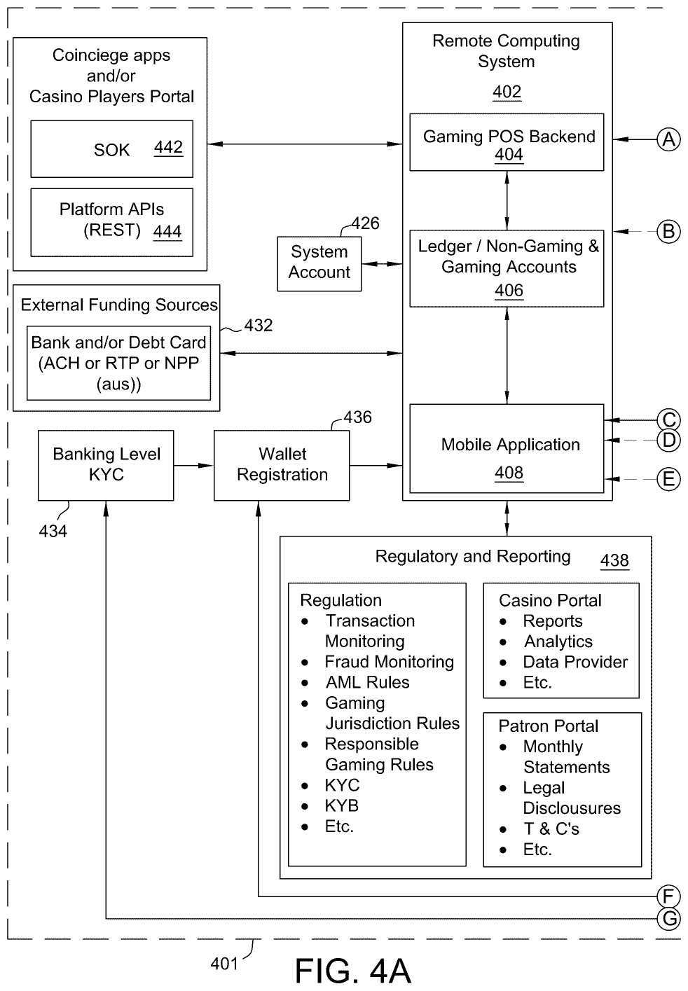

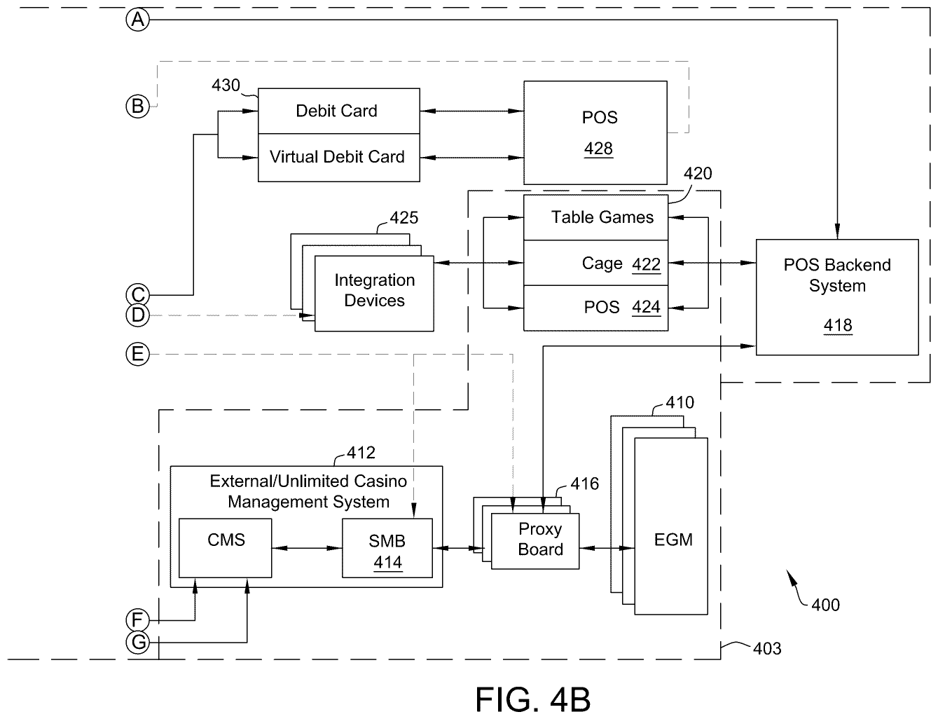

The specific details of the UPS are described below in more detail with respect to FIGS. 4-20.

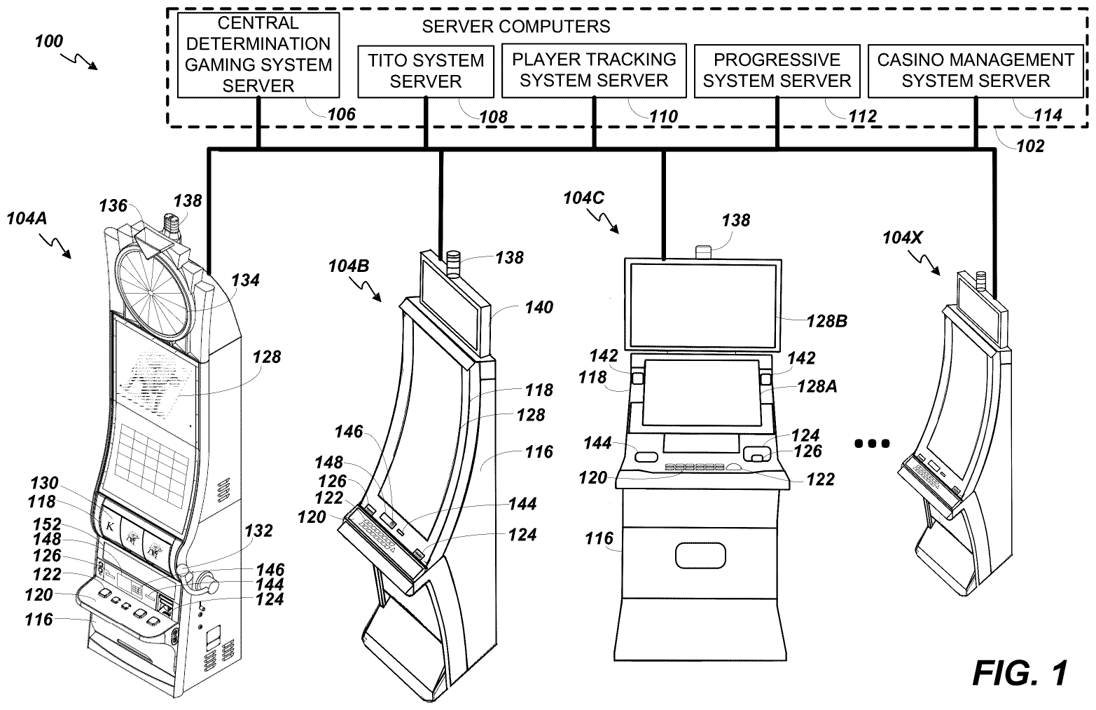

FIG. 1 illustrates several different models of EGMs which may be networked to various gaming related servers in an example embodiment. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a CMS server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

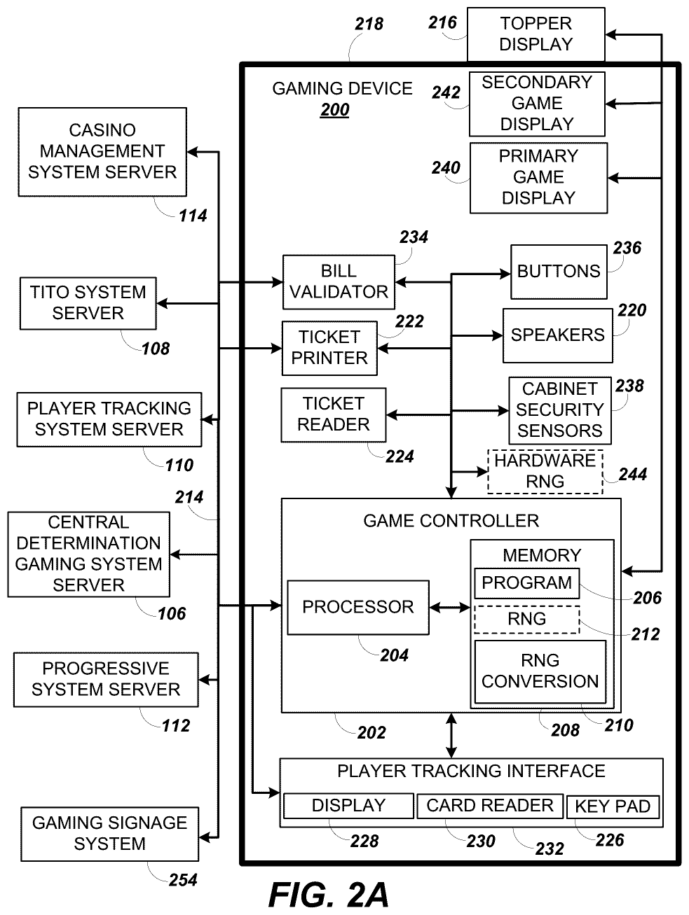

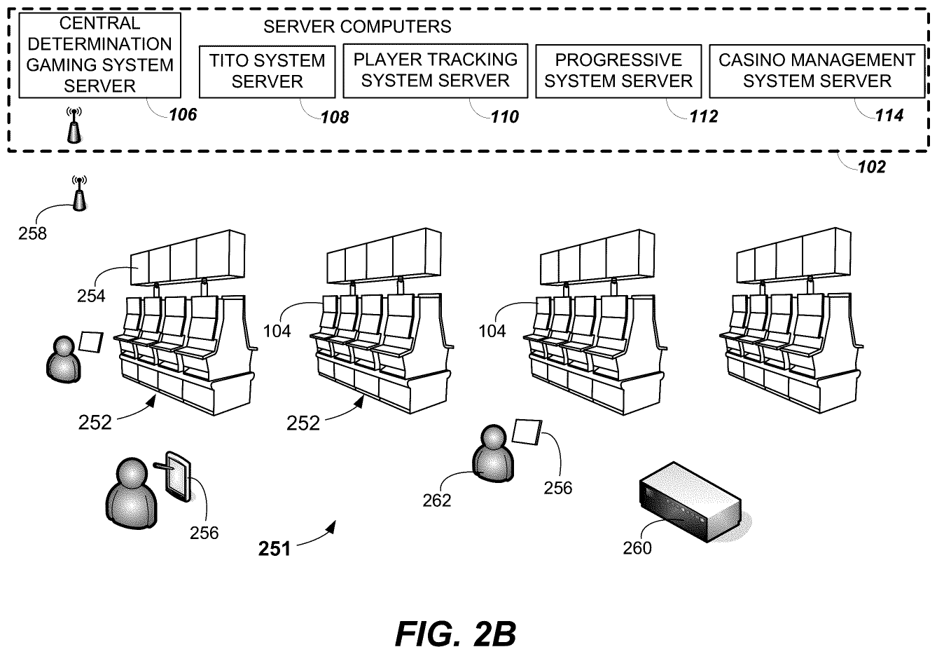

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting various functional elements of a gaming device 200 (e.g., an EGM) in an example embodiment. All or parts of gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a CMS.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment in an example embodiment. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

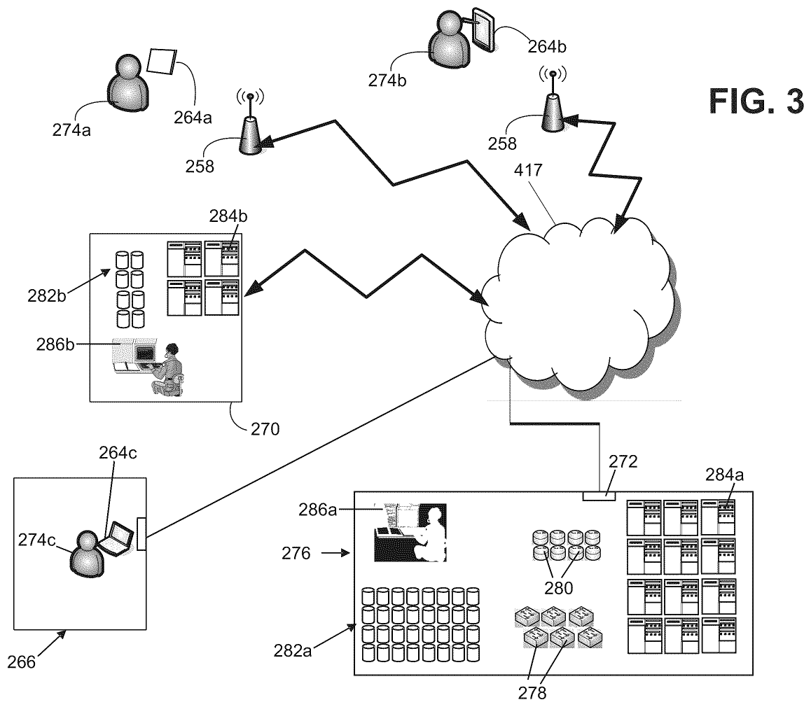

FIG. 3 is a diagram of components of a system for providing online gaming in an example embodiment. As with other figures presented in this disclosure, the numbers, types and arrangements of gaming devices shown in FIG. 3 are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 3. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 3, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

FIGS. 4A and 4B illustrate an overview of some of the components and services of a gaming system 400 according to an example embodiment. Gaming system 400 may include a UPS 401 and gaming ecosystem 403 as described below. Any of the components of gaming system 400 may be performed, for example, by server computers 102 of FIG. 1. In the example embodiment, UPS 401 includes a remote computing system 402 (e.g., a cloud-based computing system), which may include one or more processors and/or memory devices configured to execute and/or provide a gaming POS backend 404, an immutable CL 406, and/or a mobile application 408, which are described in further detail below. In some embodiments, mobile application 408 may be deployed on-premises in addition to, or alternatively to, by remote computing system 402.

In the example embodiment, gaming ecosystem 403 of gaming system 400 may further include at least one EGM 410, which may be similar to gaming devices 104A-104X described above with respect to FIG. 1. EGM 410 may be configured to communicate with a CMS 412 via a slot machine interface board (SMIB) 414. EGM 410 and SMIB 414 may communicate using Slot Accounting System (SAS) protocol and/or other communication format. In the example embodiment, a proxy board 416 may be coupled between EGM 410 and SMIB 414 and may be configured to communicate with gaming POS backend 404, in some embodiments, via one or more on-premises POS backend system 418 of gaming POS backend 404. Proxy board 416 may be “invisible” to EGM 410 and/or SMIB 414, in that proxy board 416 may be configured to transmit signals to EGM 410 that EGM 410 would expect to receive from SMIB 414 and transmit signals to SMIB 414 that SMIB 414 would expect to receive from EGM 410. Thus, proxy board 416 may be installed in an existing casino environment without affecting operation or requiring reconfiguration of EGM 410, CMS 412, and/or SMIB 414. Further, proxy board 416 enables UPS 401 to be CMS-agnostic, in that gaming system 400 does not require CMS 412 to be of a specific design, model, and/or manufacturer. In some embodiments, proxy board 416 may include a wireless transceiver and/or imaging device to utilize Bluetooth, near field communication (NFC), cameras, quick response (QR) codes, bar codes, data entry forms, or other forms of communication to EGM 410 to communicate with or otherwise link transactions with a user device executing mobile application 408.

In some embodiments, a registration, such as a players club registration via CMS 412, may be used to register the user into a player database of the casino. In such embodiments, this registration may indicate whether the user has enrolled with the digital wallet system provided by UPS 401 and may be linked to one or more virtual accounts (e.g., a top-level account and one or more sub-accounts) associated with the user within UPS 401. The user may be able to link this digital wallet functionality provided by UPS 401 to multiple different players club registrations, which may be associated with multiple casino organizations. The user may be able to see what casinos are linked (e.g., using mobile application 408), and a casino organization may only have access to player information originating from their organization, and not information from other organizations. When the user requests to load funds onto, for example, EGM 410, virtual funds may be transferred from a venue gaming account managed and tracked locally with CMS 412 to EGM 410. There may not be any direct actual funds moved from system account 426 associated with the user to the venue gaming account managed and tracked by CMS 412. Instead, virtual funds transfer may be recorded in immutable CL 406 as described below. CMS 412 may provide information gathering and club registration, if applicable, via standard APIs.

In the example embodiment shown in FIGS. 4A and 4B, UPS 401 is connected to table games 420 (e.g., smart table games), cages 422 (e.g., points at which tickets or vouchers may be exchanged for cash), and/or on-premises POSs 424 (e.g., POS devices associated with stores, restaurants, hotels, and/or other merchants within the casino environment) of gaming system 400, any of which may be configured to communicate with gaming POS backend 404, for example, via on-premises POS backend system 418. Gaming system 400 may further include one or more integration devices 425, through which, table games 420, cages 422, and/or on-premises POSs 424 may be further configured to communicate with remote computing system 402 using mobile application 408. For example, integration devices 425 may utilize Bluetooth, NFC, cameras, QR codes, bar codes, data entry forms, or other forms of communication to enable table games 420, cages 422, and/or on-premises POSs 424 to communicate with or otherwise link transactions with a user device executing mobile application 408.

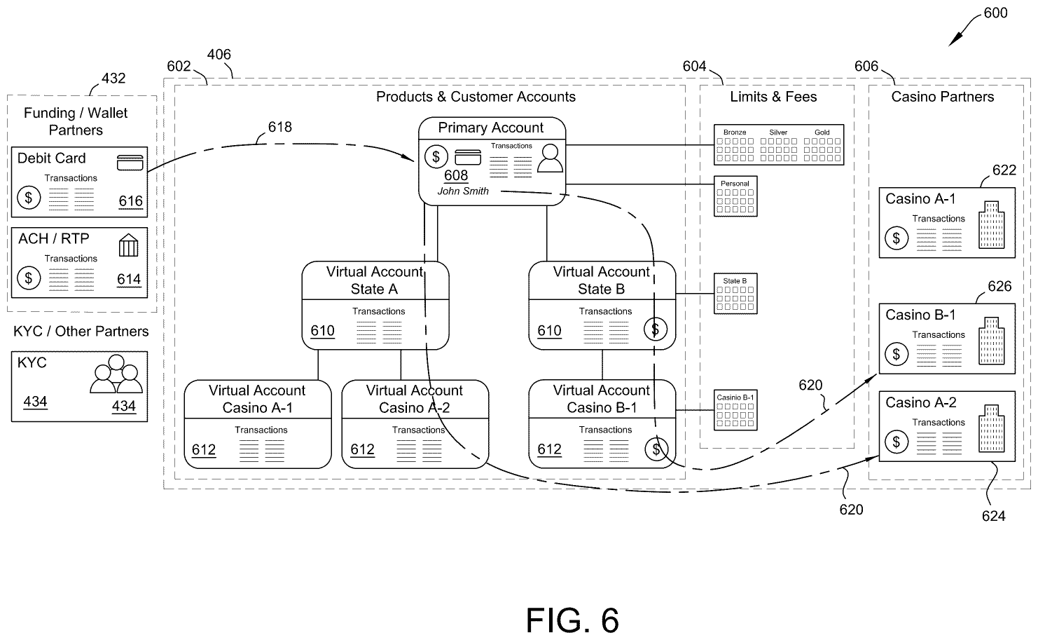

A user may use mobile application 408 to fund a system account 426. Gaming POS backend 404 may track transactions using immutable CL 406, which may be a centralized and/or intermittent ledger that tracks both gaming transactions across different casino properties and non-gaming transactions for system account 426. In the exemplary embodiment, immutable CL 406 may be a single master ledger, where transactions recorded in immutable CL 406 are immutable. Immutable CL 406 may include sub-ledgers, which are also referenced as virtual accounts (as described in further detail below with respect to FIG. 6), and all sub-ledgers may roll up to the single immutable CL.

With regards to gaming transactions or other transactions conducted on-site at a casino (e.g., at EGM 410, table games 420, cage 422, and/or on-premises POS 424), by utilizing immutable CL 406, UPS 401 may track these transactions without transferring actual funds in real-time from system account 426 to EGMs 410. Instead, when a user requests to load funds onto EGM 410 using mobile application 408, gaming POS backend 404 may use immutable CL 406 to check whether the amount of funds requested from the user exceeds the current balance stored in the corresponding primary account in immutable CL 406. If the current balance exceeds the amount of funds requested, gaming POS backend 404 updates the current balance stored within immutable CL 406 (e.g., deducts the requested amount of funds from the amount of funds recorded as being associated with the primary account) and authorizes the transfer of virtual funds from the primary account to the venue gaming account while all actual funds remain stored in system account 426. From the venue gaming account, the CMS 412 automatically (without user input) transfers the virtual funds to EGM 410 via the proxy board 416 and/or SMIB 414.

Because these virtual transfers of funds do not result in actual transfers of money into or out of the system account, UPS 401 provides certain technical benefits when executing gaming transactions in this manner, such as reducing a number of data messages and/or communication bandwidth between computers needed to complete the transaction, reducing a number of computing processing steps needed to complete the transaction thereby reducing a need for computer processing power, and lowering and/or eliminating the transaction fees associated with funding play on a gaming device such as EGM 410. UPS 401 may perform an end of day settlement for one or more of the venue virtual accounts to transfer funds to and/or from the system account 426.

In some embodiments, to load funds onto EGM 410, the mobile phone of the user may send a request to load funds to proxy board 416 and/or CMS 412 in response to the user inputting a request via mobile application 408. Such a request may also be input by the user via EGM 410 itself, in which case the request may include identifying information, such as loyalty card information associated with the user. In embodiments wherein the request is received by proxy board 416, proxy board 416 may be configured to forward such requests via on-premises POS backend system 418 to gaming POS backend 404, which may then lookup information in immutable CL 406 (e.g., whether the user associated with the mobile phone or carded into the EGM 410 from which the request was received is enrolled and has sufficient funds in the corresponding virtual user account) to determine whether to approve the request. If the request to load funds onto EGM 410 is approved, gaming POS backend 404 may create and/or store a pending ledger transaction in immutable CL 406 and may send an approval message back to POS backend system 418, which may instruct proxy board 416 and/or CMS 412 to load funds onto EGM 410. CMS 412 may then load funds onto EGM 410 using a cashless payment system of the corresponding venue and communicating with EGM 410 via proxy board 416. When proxy board 416 confirms to POS backend system 418 that the funds have been loaded onto EGM 410, POS backend system 418 may transmit this confirmation to gaming POS backend 404, which may then update immutable CL 406 to finalize and make official the ledger transaction.

Similarly, transactions made at on-premises POS 424 (sometimes referred to herein as “closed loop” transactions) may not go through the traditional financial rails (e.g., external payment processing networks or interchange networks) to complete a transaction request but may be completed by using gaming POS backend 404 to update the current balance or funds value stored within immutable CL 406 and performing a single end of day settlement. By doing so, casinos and/or users may be charged a lower fee by utilizing UPS than other digital wallets and/or traditional credit/debit card transactions.

For non-gaming transactions (sometimes referred to herein as “open loop” transactions), for example, at an off-premises POS 428 (e.g., retail POS, Apple Pay, and Google Pay), gaming POS backend 404 documents such non-gaming transactions on immutable CL 406. In contrast to the gaming transactions described above, funds may be withdrawn from system account 426 individually and/or in real-time to complete such non-gaming transactions. Non-gaming transactions may incur transactions fees because of the fund transfer from stored value account stored in system account 426. In some embodiments, a debit card 430 may be issued to the user for making such off-site purchases. Debit card 430 may be a physical and/or a virtual (e.g., registered in a virtual wallet such as Apple Wallet and/or Google Wallet) card. In contrast to a traditional debit card, purchases made with debit card 430 are withdrawn from system account 426 and documented in immutable CL 406. In some embodiments, transactions may be made using debit card 430 at any POS/online/etc. that accepts debit transactions. These transactions may be settled using traditional financial rails (payment processing networks) as any other debit card product. They will not be used for any gaming transactions. In some such embodiments, debit card 430 may also be used for closed-loop on-site purchases, for example, using on-premises POS 424.

System account 426 may be funded from one or more external funding sources 432, which may be, for example, a linked bank account and/or a linked debit card and may function similarly to PayPal or other similar products. For example, a user may, using mobile application 408, transfer funds from external funding source 432 to system account 426, and an updated balance for the user may be recorded in immutable CL 406. Know your customer (KYC) information 434 may be used for verifying a wallet registration 436 using mobile application 408, which may result in one or more virtual accounts being generated and recorded for the user in immutable CL 406, as described in further detail below. In some embodiments, a KYC call may be performed during funds transfers and/or loading actions, in which KYC information 434 may be used to determine if player data in the system matches what is returned from other KYC sources.

In some embodiments, remote computing system 402 may provide a portal 438 (e.g., a user interface) for displaying information, for example, to regulators, casino operators, and/or patrons/users. For example, the portal may display information relating to or enable an application of transaction monitoring, fraud/anti-money laundering rules, gaming jurisdiction rules, KYC information, know your business (KYB) information, reports, analytics, monthly statements, legal disclosures, terms and conductions, and/or other information. In some such embodiments, portal 438 may be accessible though mobile application 408.

In some embodiments, UPS system may include one or more casino apps and/or casino players portals 440, which may include a software development kit (SDK) 442 and/or platform application programming interface (API) 444 that enable a casino operator (or contracted developer) to imbed universal wallet functionality (e.g., an ability to load and/or transfer funds) within their branded casino apps and/or casino players portals 440.

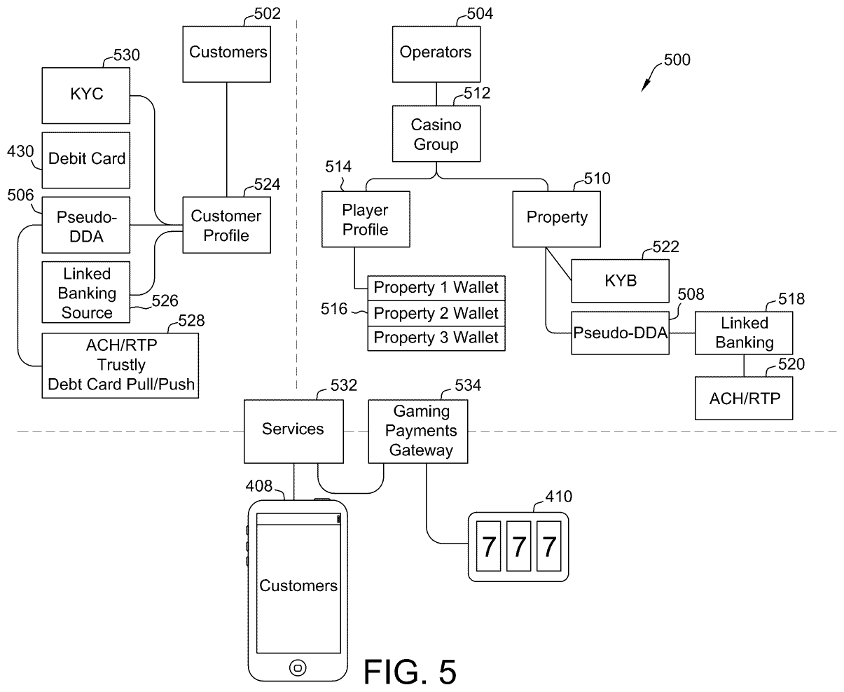

FIG. 5 is a block diagram 500 illustrating functional/logical operations of UPS 401 (shown in FIGS. 4A and 4B). In FIG. 5, the left-hand depicts customer-side operations associated with a customer 502 (e.g., a user), and the right-hand depicts operator-side operations associated with an operator 504 (e.g., an operator of UPS 401 shown in FIGS. 4A and 4B). The customer-side operations has a customer virtual account 506 setup for the customer, which may be a virtual user account defined by immutable CL 406, and the operator-side operations has a venue virtual account 508, which may be another virtual account defined by immutable CL 406, setup for a casino property 510. When payments are settled (e.g., at the end of a day or other predefined period), funds are transferred between system account 426 and external accounts (e.g., property bank account 518, described below) based on values associated with virtual funds transfers recorded in immutable CL 406.

The operator-side operations may include a player profile 512 for a given casino group 514. Each player profile that is created may be linked to a property wallet 516 at each property 510. The property wallets 516 represent the venue gaming accounts used to fund gaming transactions at respective properties 510. Each property 510 may own and control the venue gaming accounts, which are separate accounts from the customer virtual account 506 and are separate from immutable CL 406. Property virtual account 508 may be linked to a property bank account 518, and funds may be transferred between property virtual account 508 and property bank account 518 using an electronic payment system 520 (e.g., automated clearing house (ACH), real-time payment (RTP), and/or another proprietary or public electronic payment system). A know your business (KYB) operation 522 may be used to ensure compliance with anti-money laundering and security requirements.

The customer-side operations may include a customer profile 524 for a given customer or user. Customer profile 524 may be linked to customer virtual account 506. Customer virtual account 506 may be linked to a customer bank account 526, and funds may be transferred between customer virtual account 506 and customer bank account 526 using an electronic payment system 528 (e.g., ACH or RTP). In some embodiments, as described with respect to FIGS. 4A and 4B, debit card 430 may be issued and/or linked to customer virtual account 506 to make on-site or off-site purchases using funds from customer virtual account 506. A KYC operation 530 may be used to ensure compliance with anti-money laundering and security requirements.

A pay services operation 532 and gaming payments gateway 534 may be implemented using, for example, remote computing system 402 shown in FIGS. 4A and 4B, to enable customer 502 to use mobile application 408 to initiate a virtual transfer of funds or credits from customer virtual account 506 for use at EGM 410. When these funds or credits are transferred by customer 502 to EGM 410 (e.g., by wagering the funds or credits), these funds or credits may be virtually transferred within system account 426 from customer virtual account 506 to property virtual account 508. The funds may then be transferred to EGM 410 from a cashless payment system associated with operator 504. Gaming payments gateway 534 may provide additional functionality such as, for example, verifying a user exists and/or creating a player account.

FIG. 6 is a block diagram of an exemplary centralized ledger system 600, which may be implemented using immutable CL 406 and/or external funding source 432 shown in FIGS. 4A and 4B. Immutable CL 406 may define and/or record one or more virtual customer accounts 602, limits and fees 604, and/or casino accounts 606.

Customer accounts 602 may include or be associated with one or more primary accounts 608, which are virtual user accounts defined by records stored in immutable CL 406. Primary account 608 may be associated with a user, and may be linked to one or more virtual user sub-accounts for tracking transactions made by a user associated with primary account 608. For example, in the exemplary embodiment depicted in FIG. 6, primary account 608 is associated with virtual user sub-accounts 610 corresponding to different jurisdictions (e.g., national or state governments, tribal organizations), which may be further linked to or broken down into virtual user sub-accounts 612 for tracking transactions at different casinos or other partnering organizations. Because each virtual user sub-account 612 is associated with a different jurisdiction and a different casino, different limits and fees 604 may be applied to each virtual user sub-account 612 when transferring funds to or from virtual user sub-account 612. For example, limits and fees 604 may include different tiers of fee plans, user-defined limits associated with a particular user, state or jurisdiction-defined limits corresponding to a particular jurisdiction, and/or casino or operator-defined limits corresponding to a particular operator or casino location.

It should be appreciated that the ledger structure of immutable CL 406 depicted in FIG. 6 is an example ledger structure, and that other ledger structures may be used to implement immutable CL 406. For example, in some embodiments, virtual sub-accounts 610 corresponding to different jurisdictions may not be included (e.g., in cases in which regulators do not need to track this information).

A customer may transfer actual funds to primary account 608 using external funding sources 432, such as an electronic payment 614 (e.g., ACH or RTP) and/or a debit card 616, which may result in immutable CL 406 being updated to reflect the transfer being added to the balance of one or more virtual user accounts 610 associated with the user. This actual transfer of funds is illustrated by arrow 618. Certain situations may result in a virtual transfer of funds between virtual user sub-accounts 612. For example, if the customer attempts to load credits onto an EGM 410 located at a particular casino using mobile application 408, a certain amount of funds may be automatically allocated to a virtual user sub-account 612 associated with that casino before being transferred to a casino account 606 associated with that casino in order to ensure that appropriate limits and fees 604, for example, may be applied to this transaction. Similarly, if the customer earns credit from the casino (e.g., by winning a prize using EGM 410), funds may be transferred from casino account 606 associated with the casino to a corresponding virtual user sub-account 612.

Notably, any transfers between virtual accounts, are implemented by generating records within immutable CL 406, while all the funds remain stored in system account 426 (shown in FIGS. 4A and 4B). Thus, use of traditional transfer systems and protocols and associated fees are not necessary for these virtual transactions, such as those between virtual user sub-accounts 612 and casino accounts (indicated by arrows 620) in implementations in which casino accounts are virtual accounts associated with actual funds stored in system account 426.

Casino accounts 606 may be associated with different respective casino properties, with each casino property having its own ledger account. For example, if a casino operator has 12 properties, each of the 12 properties may have at least one of its own casino account 606. For example, as shown in FIG. 6, casino accounts 606 may include a first casino account 622 (“Casino A-1”) and a second casino account 624 (“Casino A-2”) that are associated with a first casino operator and a third casino account 626 (“Casino B-1”) that associated with a second, different casino operator.

During the course of a predefined period (e.g., a day), debits and credits between customer accounts 602 and casino accounts 606 are recorded in immutable CL 406, and at the end of the period, these debits and credits may be settled to account for all the transfers during the period. For example, if a casino associated with a virtual casino account 606 has experienced a net loss for the period, virtual casino account 606 may have a negative balance, and an operator associated with this virtual casino account 606 may be required to make an actual transfer of funds from an external account into system account 426 to cover this negative balance. In some embodiments, this transfer may be performed automatically. On the other hand, if there is a positive balance within a virtual casino account, an operator associated with the account may be able to withdraw at least some of this balance, resulting in an actual transfer of this value from system account 426 to an external account associated with the operator.

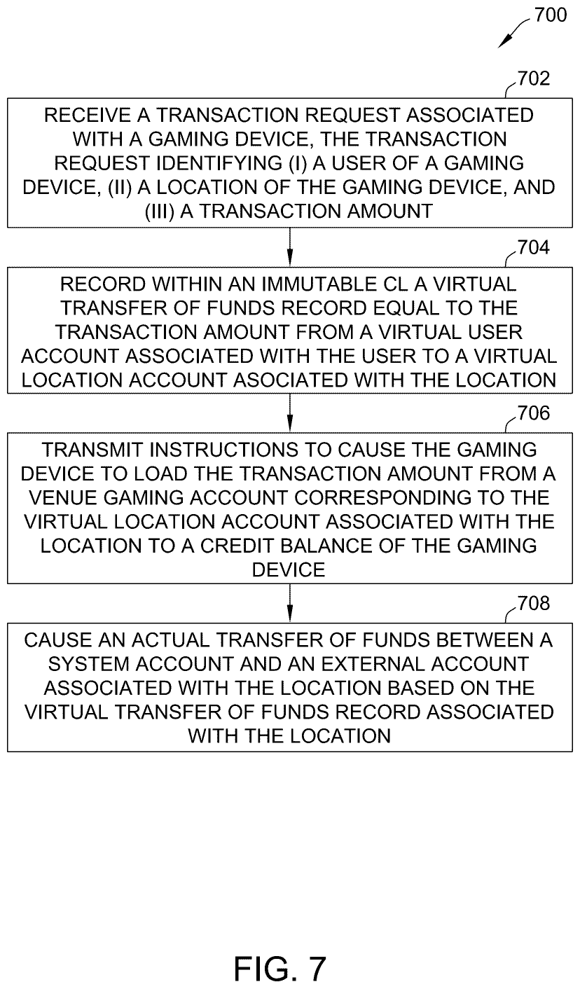

FIG. 7 is a flowchart illustrating an exemplary method 700 for transferring funds to EGM 410 using UPS 401 in a closed-loop transaction that does not result in a transfer of actual funds from system account 426.

Method 700 may include receiving 702 a transaction request associated with EGM 410 (e.g., from proxy board 416). The transaction request may identify (i) a user of EGM 410, (ii) a location (e.g., a particular casino site) of EGM 410, and (iii) a transaction amount (e.g., an amount the user wishes to transfer to a credit balance of EGM 410). In addition to EGM 410, similar transaction requests may be received from, for example, integration devices 425 to facilitate transactions at table games 420, cages 422, and/or on-premises POS 424.

Method 700 may further include in response to receiving the transaction request, recording 704 in immutable CL 406 a virtual transfer of funds record equal to the transaction amount from a virtual user account associated with the user to a virtual location account associated with the location of EGM 410. For example, immutable CL 406 may record a virtual user account associated with the user and another account associated with the location and may record a virtual transfer between the user's account and the location's account without actually transferring funds in or out of system account 426. This record of the transaction stored in immutable CL 406 may be immutable.

Method 700 may further include transmitting 706, for example to proxy board 416, instructions to cause EGM 410 to load the transaction amount from a venue gaming account corresponding to the virtual location account associated with the location to a credit balance of EGM 410. For example, if the user's account includes sufficient funds to cover the transaction amount, a cashless payment system associated with the location may be used to transfer funds from a venue gaming account associated with the location to EGM 410.

Method 700 may further include causing 708 an actual transfer of funds, between system account 426 and an external account associated with the location (e.g., an account associated with the casino operator), based on the virtual transfer of funds record associated with the location. In some embodiments, this actual transfer may be performed in aggregate with, for example, all the funds transfers for the location associated with a plurality of users for a predefined time period. Accordingly, for on-site closed loop transactions, funds transfers from system account 426 may be performed only periodically (e.g., once a day), rather than for each transaction.

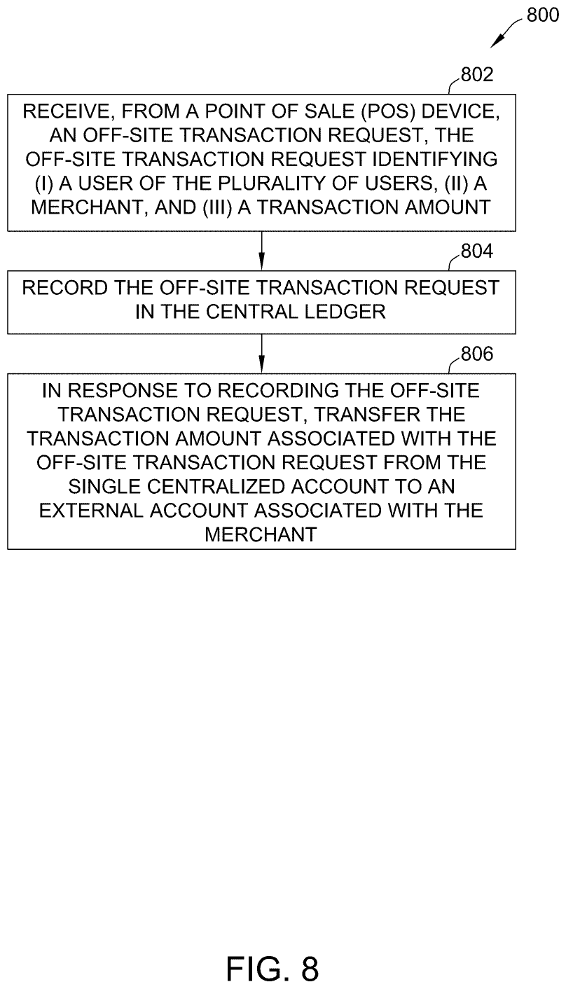

FIG. 8 is a flowchart illustrating an exemplary method 800 for off-site or open-loop transactions using UPS 401, for example, using debit card 430. Unlike the closed-loop transaction described above with respect to FIG. 7, this open-loop transaction may result in a corresponding transfer of actual funds.

Method 800 may include receiving 802, from off-premises POS 428, an off-site transaction request, the off-site transaction request identifying (i) a user of the plurality of users, (ii) a merchant, and (iii) a transaction amount. The transaction request may be generated in response to, for example, a card swipe or chip input at a POS terminal or an input of debit card information to an online site.

Method 800 may further include recording 804 the off-site transaction request in immutable CL 406. For example, immutable CL 406 may record a sub-account associated with debit card 430, and record a deduction of the transaction amount from this sub-account. This transaction request recorded in immutable CL 406 may be immutable.

Method 800 may further include, in response to recording the off-site transaction request, causing an 806 an actual transfer of the second transaction amount associated with the off-site transaction request from system account 426 to an external account associated with the merchant. This contrasts from the closed loop transactions described with respect to method 700 shown in FIG. 7. Nonetheless, both open loop and closed loop transactions may be performed by the same UPS 401, in some cases, using debit card 430.

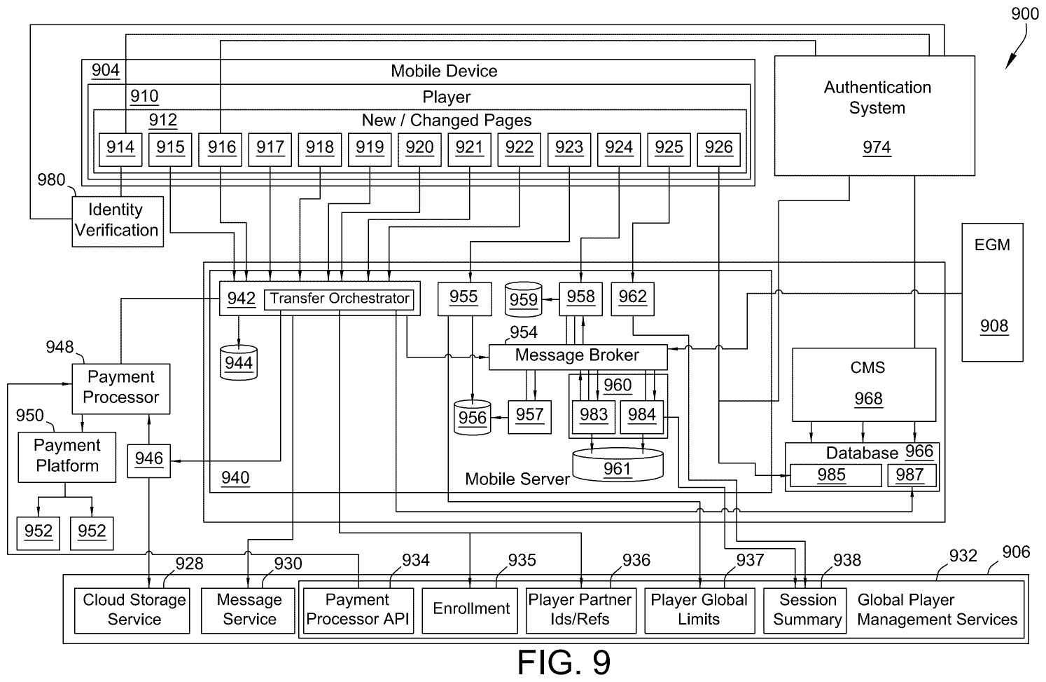

FIG. 9 illustrates an example overview of certain components and services of a gaming system 900 that may provide a digital wallet system according to an example embodiment of the present disclosure. At least some of the components of gaming system 900 may be executed, for example, by server computers 102 of FIG. 1. In some exemplary embodiments, gaming system 900 is similar to gaming system 400 (shown in FIGS. 4A and 4B). gaming system 900 includes a venue system 902, one or more mobile devices 904, a cloud system 906, and at least one EGM 908. Venue system 902 is configured to communicate with mobile device 904, cloud system 906, and EGM 908.

Mobile device 904 may be configured to execute a mobile application 910, which may be configured to cause mobile device 904 to display one of a plurality of pages 912 through which a user may input information to and/or view information received from venue system 902 and/or cloud system 906. Some examples of pages 912 include a wallet enroll page 914, a player home page 915, a sign-in page 916, a link external account page 917, a frequently asked questions (FAQ) page 918, a funds transfer page 919, a payout page 920, a wallet home page 921, a transaction history page 922, a responsible gaming (RG) limits page 923, a locator page 924, an activity summary page 925, and/or a self-exclusion page 926, which are described in further detail below.

Cloud system 906 may include a cloud storage service 928, a message service 930, and a global player management service 932. Cloud storage service 928 may provide data storage for various components of gaming system 900, and message service 930 may enable internet-based communication between remote components of gaming system 900. Global player management service 932 may be capable of providing player management services across multiple venues and/or operators, and may include a plurality of services including, for example, a payment processor API 934, an enrollment service 935, a player partner ID service 936, a player global limits service 937, and/or a session summary service 938, which are described in further detail below. As described in further detail below, global player management service 932 may map a single player database record to multiple venue database records (e.g., records stored at different venue systems 902), thereby enabling a user's activity to be tracked across many different venues.

Venue system 902 may include a mobile server 940 configured to fulfill requests received from and provide information to mobile application 910. Mobile server 940 may include a wallet transfer orchestrator 942 and a wallet database 944 in communication with wallet transfer orchestrator 942. Wallet transfer orchestrator 942 is further in communication with a ledger 946 and payment processor 948. Ledger 946 may function similarly to immutable CL 406 described above with respect to FIGS. 4-6, and in some embodiments, may be managed by a third party (e.g., an entity separate from that managing venue system 902 and/or cloud system 906) and/or be stored in a remote location (e.g., using cloud storage service 928). Payment processor 948 may be, for example, a payment card processing entity, ACH, or other entity capable of facilitating electronic payments, and may be in communication with a payment platform 950 (e.g., a payment card interchange network), which enables payment processor to settle funds between accounts at banks 952 based on transactions recorded immutably in ledger 946, as described above with respect to immutable CL 406.

In addition to wallet transfer orchestrator 942, mobile server 940 may include other components configured to enable communication between venue system 902, mobile device 904, cloud system 906, and EGM 908. These components may include, for example, a message broker 954, a dynamic messaging module 955, a dynamic messaging database 956, a dynamic messaging listener 957, a player device module 958, a player device database 959, a player activity module 960, a player activity database 961, and/or player activity APIs 962, which are described in further detail below.

Venue system 902 may further include a CMS database 966 and a player tracking system or CMS 968, which in some embodiments, may be incorporated into mobile server 940. In some embodiments, gaming system 900 may be CMS-agnostic, in that gaming system 900 does not require any integrated components of CMS 968 to be of a specific design, model, and/or manufacturer. For example, as described above with respect to UPS 401, gaming system 900 may include components capable of communicating with multiple different types of CMS 968.

In some embodiments, gaming system 900 further includes an authentication system 974 in communication with venue system 902, mobile device 904, and/or cloud system 906. Authentication system 974 may be configured to store confirmed identification data obtained from CMS 968 and may be used to verify identification data using, for example, messaging services (e.g., transmitting messages to and receiving confirmation from mobile device 904).

As described above, mobile application 910 may include wallet enroll page 914 through which a user may enroll with the digital wallet system. For example, the user may input identification information and/or information relating to financial and/or casino loyalty accounts associated with the user. Mobile device 904 may communicate with an identity verification server 980, which may verify the user's identity and eligibility to enroll with the digital wallet system using information retrieved from, for example, watchlists and/or government databases. Wallet transfer orchestrator 942 may use this data to create records associated with the user in wallet database 944, and, when funding is provided, corresponding user accounts may be generated in ledger 946 as described above with respect to FIG. 6. This identification and enrollment information may be further stored and/or verified by cloud system 906 using, for example, enrollment service 935 and/or player partner ID service 936.

Mobile application 910 may further include player home page 915, which may be an initial page displayed upon opening mobile application and which may provide links to other pages 912 within mobile application 910. In some embodiments, player home page 915 may display a current wallet status and/or balances. Mobile application 910 may retrieve this information from wallet database 944 and/or ledger 946 by communicating with wallet transfer orchestrator 942.

Mobile application 910 may further include sign-in page 916, which may enable the user to sign into mobile application 910 to access the digital wallet system, for example, by entering a username and password. Once entered, this information may be compared to information stored, for example, in wallet database 944 and the user may be signed in if the information matches the corresponding records.

Mobile application 910 may further include link external account page 917, through which the user may link external bank accounts to the digital wallet system. Identifiers associated with these linked accounts (e.g., account numbers and/or routing numbers) may be stored in wallet database 944 in association with the corresponding user. These linked accounts may be used to transfer money into our out of the digital wallet system, with these transfers being recorded in ledger 946, and with money transferred into the account being stored in a universal account such as system account 426.

Mobile application 910 may further include FAQ page 918, which may be used to retrieve and display information to the user. For example, mobile application may retrieve information from wallet database 944 and/or ledger 946 to display a current wallet balance.

Mobile application 910 may further include funds transfer page 919, which the user may use to load a user-defined value of additional funds onto an EGM from the digital wallet system. These user-defined values may be stored in wallet database 944 and used by wallet transfer orchestrator 942 to execute funds transfers.

Mobile application 910 may further include payout page 920, which may be used by the user to withdraw money from the digital wallet system and transfer the money, for example, to a designated linked account. Though payout page 920, the user may specify an amount of money to withdrawn and a desired destination account. Based on this information, wallet transfer orchestrator 942 may instruct payment processor 948 to transfer the specified amount to the designated account and record this transfer and resulting change in balance in ledger 946.

Mobile application 910 may further include wallet home page 921, through which the user may view information relating to the digital wallet system. For example, mobile application may retrieve information from wallet database 944 and/or ledger 946 to display a current wallet balance. Wallet home page 921 may also serve as a default page and/or include links to other pages within mobile application 910.

Mobile application 910 may further include transaction history page 922 that enables the user to view a history of previous transactions. Because data relating to gaming and other transactions flows through message broker 542, as described in further detail below, dynamic messaging listener 957 may record data relating to these transactions in dynamic messaging database 956. When a request is made via mobile application 910, dynamic messaging module 955 may retrieve this data and transmit the data to mobile device 904 for presenting in transaction history page 922.

Mobile application 910 may further include responsible gaming limits page 923, through which a user may set spend limits and/or time limits (e.g., the user may only spend a certain amount or spend a certain amount of gaming within a predefined period). These specified limits may be communicated to and recorded with player global limits service 937 of cloud system 906. The user's playing activity may be tracked, based on data passed through message broker 954, at different respective venues by player activity module 960 and stored in player activity database 961. For example, player activity module may include an EGM session processor 983 that identifies activity (e.g., spending, time logged in and/or in an active gaming session) at EGMs such as EGM 908. Player activity module 960 may further include a global player publisher 984 that transfers this data to session summary service 938 at cloud system 906. Player global limits service 937 is able to access data this data, so that player activity across multiple different venues can be tracked and responsible gaming limits can be enforced at all connected venues based on this data.

Mobile application 910 may further include locator page 924, which may utilize player device data stored by player device module 958 in player device database 959 to determine mobile device 904 is located at a particular venue associated with venue system 902.

Mobile application 910 may further include activity summary page 925 which enables the user to view a summary of playing activity across all venues associated with the digital wallet system. As described above, this activity may be stored by session summary service 938 based on data received from player activity module 960. Mobile device 904 may communicate with session summary service 938 via player activity APIs 962 to retrieve this activity data and display the data using activity summary page 925.

Mobile application 910 may further include a self-exclusion page 926, through which the user may view a self-exclusion status and/or which may control and/or alter functionality of mobile application 910 based on the user's self exclusion status. For example, some or all of the functionality of the digital wallet system may be unavailable to self excluded individuals. To determine this status, mobile device 904 may communicate with CMS database 966, via self-exclusion module 963, which may include a self-exclusion list 985.

In some embodiments, EGM 908 is capable of providing at least some of the functions described with respect to pages 912 of mobile application 910.

EGM 908 may be configured to communicate with venue system 902. When a user wishes to initiate gameplay at EGM 908 using funds they have stored in a virtual account using the digital wallet system, the user may log into EGM 908 using their digital wallet system account and/or a linked casino loyalty account, swiping a loyalty card and/or otherwise provide information enabling the user's virtual wallet to be identified.

To load money from the digital wallet system onto EGM 908 to be used for gameplay, a gaming transaction may be initiated as described above. A transaction request may be transmitted from EGM 908 to wallet transfer orchestrator 942 via message broker 954. Wallet transfer orchestrator 942 may query wallet database 944 and/or ledger 946 to determine if there are sufficient funds associated with the user, and if so, virtual wallet may record a transfer of the funds from a virtual account associated with the user the user to a virtual account associated with an operator or venue associated with EGM 908 in ledger 946 (e.g., without a funds transfer between external accounts occurring). If a loyalty card is used, wallet transfer orchestrator 942 may perform a lookup in a card database 987 of CMS database 966 to identify the corresponding account. Wallet transfer orchestrator 942 may then transmit instructions to EGM 908, via message broker 954, to load the desired amount of credits. When the user desires to cash out at EGM 908, any remaining credits may be transferred back to the user in a similar manner, with ledger 946 being updated to record a transfer from the virtual account associated with the venue or operator to the virtual account associated with the user.

In some embodiments, mobile application 910 may be integrated with and/or connected to authentication system 974. In such embodiments, authentication system 974 may generate and store an authentication status the user. Authentication system 974 may communicate with venue system 902, for example, to verify the user is not on self-exclusion list 985 and to facilitate gaming transactions using the digital wallet system similar to those described with respect to EGM 908.

In some embodiments, certain types of use of gaming system 900 may trigger or require a payment of fees to an operator of gaming system 900. For example operators associated with venue system 902 and/or EGM 908 may pay one-time and/or periodic licensing fees, and/or fees may be applied to various transactions by users and/or operators, such as deposits, withdrawals, gaming transactions, and/or non-gaming transaction described herein.

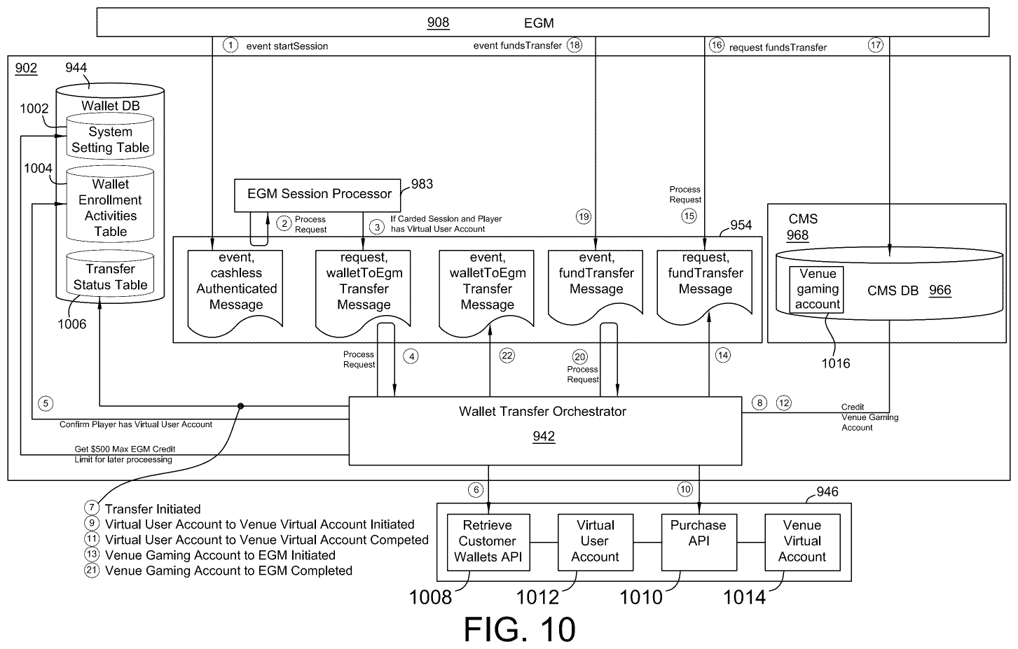

FIG. 10 illustrates example components of gaming system 900 enabling a user enrolled with a digital wallet to starts session by inserting or otherwise entering a physical card at EGM 908 and starting a carded session. As shown in FIG. 10, wallet database 944 may include system settings table 1002, a wallet enrollment activities table 104, and a transfer status table 1006.

After the card is entered, a request to establish a session and to transfer credits to EGM 908 may be transmitted, via message broker 954, to EGM session processor 983, which may establish the carded session and verify that the user has a digital wallet account. If the session is established successfully, a request to transfer credits to EGM 908 may be transmitted to wallet transfer orchestrator 942, which may query wallet enrollment activities table 1004 to confirm that the user has a digital wallet account and systems setting table 1002 to ensure that the transaction does not exceed a predefined limit. Once this confirmation is made, wallet transfer orchestrator 942 may query ledger 946 via a retrieve customer wallets API 1008 to get a current balance associated with the digital wallet account. If the balance is sufficient to execute the transfer, wallet transfer orchestrator may then initiate, via a purchase API 1010, a virtual transfer of funds from the user's virtual user account 1012 to a venue virtual account 1014 account within ledger 946. Wallet transfer orchestrator 942 may then initiate a transfer from a venue gaming account 1016 recorded in CMS database 966 to EGM 908 using a cashless payment system, and may transmit instructions, via message broker 954, to EGM 908 to load the funds. It should be appreciated that, in some embodiments, venue gaming account 1016 may be stored in a venue wallet system that is separate from a CMS such as CMS 968.

Each step of this transfer operation, such as (1) transfer initiated, (2) virtual user account 1012 to venue virtual account 1014 initiated, (3) virtual user account 1012 to venue virtual account 1014 completed, (4) venue gaming account 1016 to EGM 908 initiated, and (5) venue gaming account 1016 to EGM 908 completed, may be recorded in transfer status table 1006. Storing such statuses and confirming that such transfer and confirmation events have occurred enables operators to troubleshoot any problems if a failure occurs.

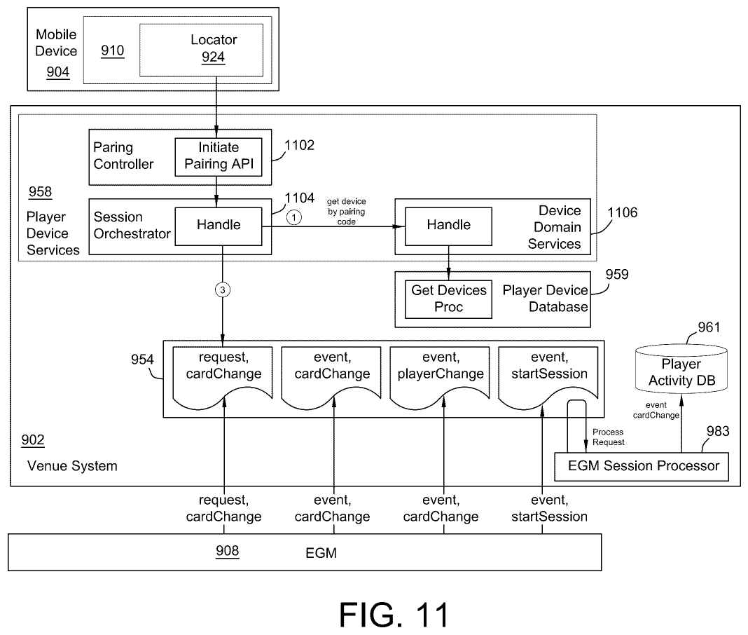

FIG. 11 illustrates example components of gaming system 900 enabling a user associated with a digital wallet account to start a session using mobile application 910. As shown in FIG. 11, player device module 958 may include a pairing controller 1102 in communication with mobile device 904, a session orchestrator 1104 in communication with message broker 954 and CMS APIs 965, and a device domain service 1106 in communication with player device database 959.

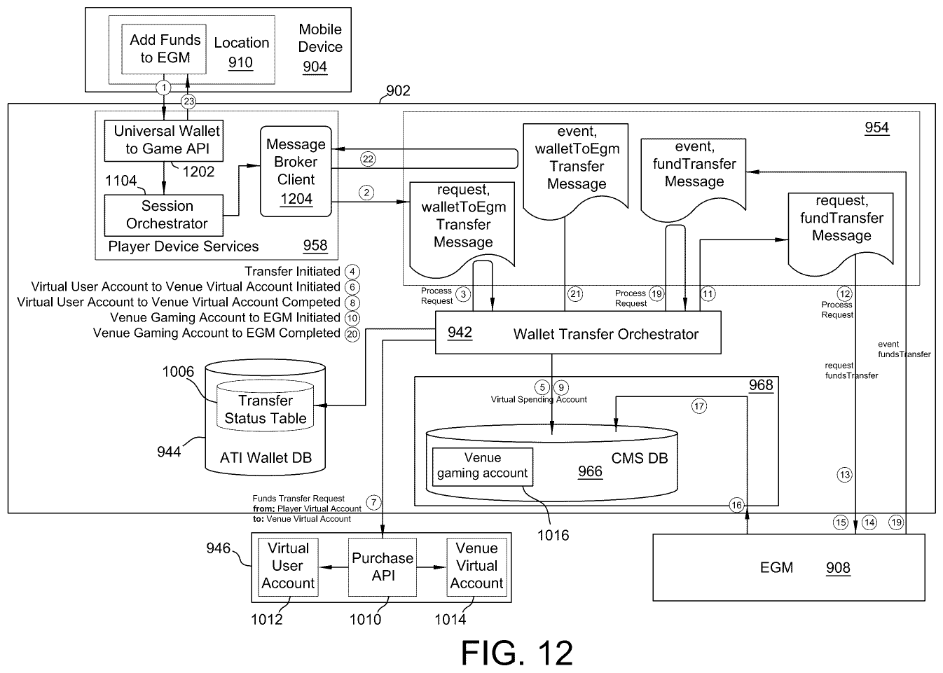

To initiate the session, mobile application 910 may provide a pairing code to pairing controller 1102. Using this pairing code, device domain service 1106 may query player device database 959 to identify mobile device 904 and the associated user. Session orchestrator 1104 may query, via CMS APIs 965, CMS 968 to determine if the identified user has an active card. If so, session orchestrator 1104 may transmit instructions via message broker 954 to EGM 908 to log in the user, and when confirmation of this login is received from EGM 908, EGM session processor 983 may record that a session is active in player activity database 961. Once the session is established, the user may initiate virtual transfers with the digital wallet system using EGM 908 in a similar manner as described with respect to FIG. 10 or using mobile application 910 as described in further detail below with respect to FIG. 12.

FIG. 12 illustrates example components of gaming system 900 that enable a user to enter an amount to transfer via mobile application 910 after a mobile session has been created. As shown in FIG. 12, player device module 958 may include a wallet-to-game API 1202 in communication with mobile device 904, and may further include a message broker client 1204 in communication with message broker 954.

When a session is established and the user enters a desired transfer amount via mobile application 910, a request to transfer credits to EGM 908 may be transmitted, via player device module 958 and message broker 954, to wallet transfer orchestrator 942. Wallet transfer orchestrator 942 may query ledger 946 to get a current balance associated with the virtual user account 1012. If the balance is sufficient to execute the transfer, wallet transfer orchestrator may then initiate a virtual transfer of funds from the virtual user account 1012 to a venue virtual account 1014 within ledger 946. Wallet transfer orchestrator 942 may then initiate a transfer from venue gaming account 1016 recorded in CMS database 966 to EGM 908 using a cashless payment system, and may transmit instructions, via message broker 954, to EGM 908 to load the funds.

Each step of this transfer operation, such as (1) transfer initiated, (2) virtual user account 1012 to venue virtual account 1014 initiated, (3) virtual user account 1012 to venue virtual account 1014 completed, (4) venue gaming account 1016 to EGM 908 initiated, and (5) venue gaming account to EGM 908 completed, may be recorded in transfer status table 1006. Storing such statuses and confirming that such transfer and confirmation events have occurred enables operators to troubleshoot any problems if a failure occurs.

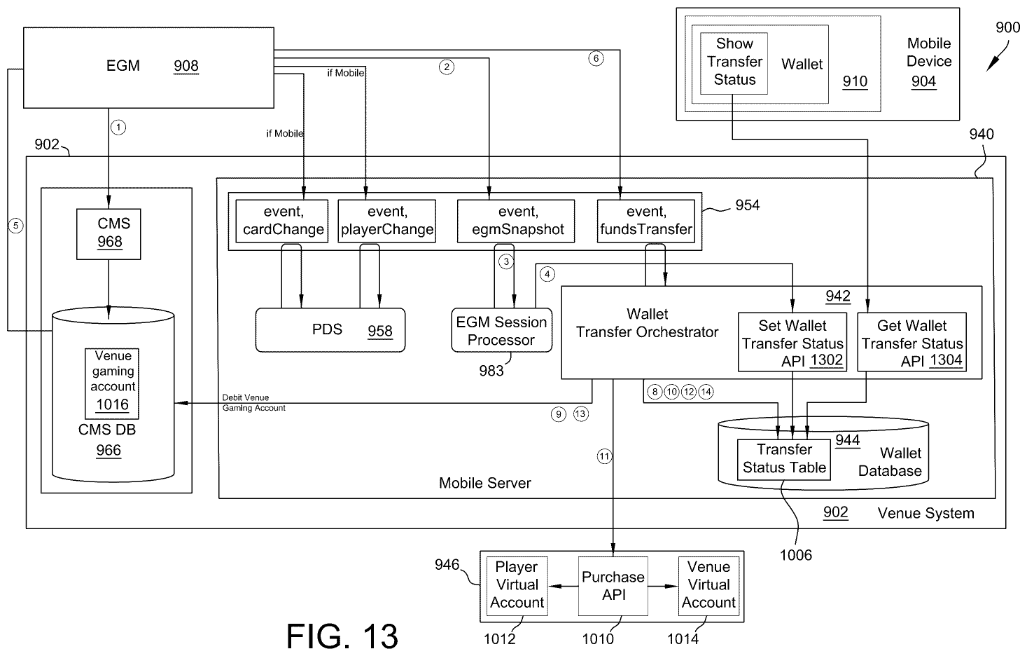

FIG. 13 illustrates example components of gaming system 900 configured to end a session in response to the user removing a card, which may result in a cashing out of any funds remaining on EGM 908 to virtual user account 1012. When the card is removed or the user otherwise logs off at EGM 908, CMS 968 may be notified via wallet transfer orchestrator 942, player device module 958, and EGM session processor 983 may be notified via message broker 954. The ending of the session may be recorded by EGM session processor 983, and wallet transfer orchestrator 942 may initiate a transfer of funds back to virtual user account 1012. To execute this transfer, wallet transfer orchestrator 942 may transfer funds from EGM 908 to the corresponding venue gaming account 1016 using the cashless payment system and record this transfer in CMS database 966. Wallet transfer orchestrator 942 may then record a virtual transfer of the funds from venue virtual account 1014 to virtual user account 1016 within ledger 946.

Each step of this transfer operation, such as (1) transfer initiated, (2) EGM 902 to venue gaming account 1016 initiated, (3) EGM 908 to venue gaming account 916 complete, (4) venue virtual account 1014 to virtual user account 1012 initiated, and (5) venue virtual account 1014 to virtual user account 1012 complete, may be recorded in transfer status table 1006. Storing such statuses and confirming that such transfer and confirmation events have occurred enables operators to troubleshoot any problems if a failure occurs. Wallet transfer orchestrator 942 may communicate with wallet database 944 via a set wallet transfer status API 1302 to update transfer status table 1006 and a get wallet transfer status API 1304 to retrieve statuses from transfer status table 1006. In some embodiments, wallet transfer orchestrator 942 may communicate with mobile device 904 enabling this status to be displayed using mobile application 910.

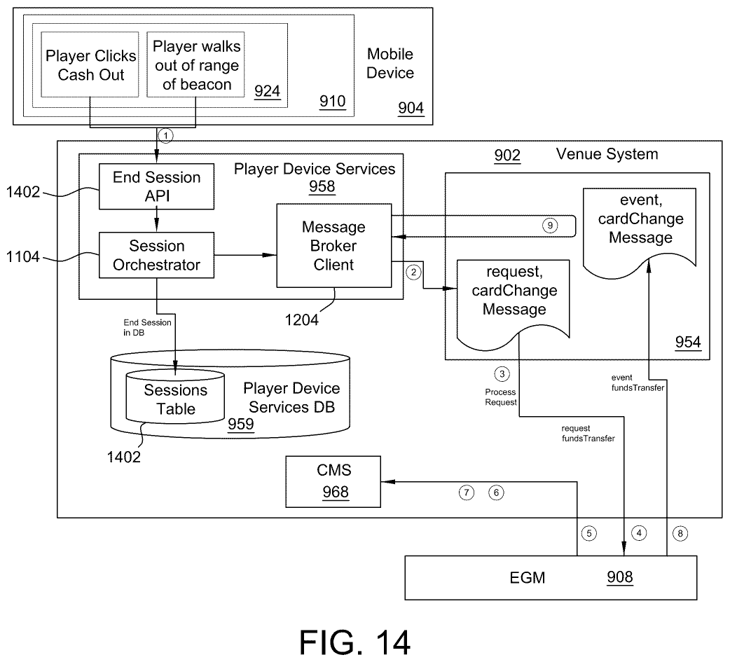

FIG. 14 illustrates example components of gaming system 900 configured to end a session in response to input received from the user using mobile application 910. As shown in FIG. 14, player device module 958 may include an end session API 1402 in communication with mobile device 904.

In response to the user selecting to cash out via mobile application 910 or mobile device 904 being moved out of range of a wireless beacon of EGM 908, mobile device 904 may transmit a message to end the session via end session API 1402. The ending of the session may be recorded by session orchestrator 1104 in a sessions table 1402 in player device database 959, and message broker client may notify EGM 908 and CMS 968 via message broker 954 that the session has ended. In response, EGM 908 may log out the player, and a transfer of funds from EGM 908 to the user's virtual wallet may be executed as described with respect to FIG. 13.

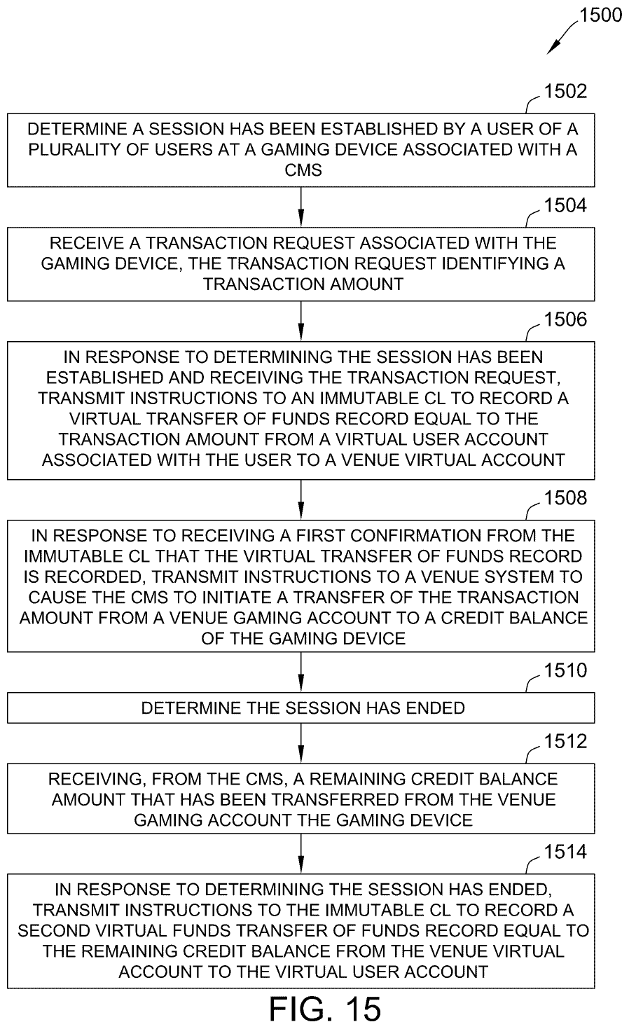

FIG. 15 is a flowchart illustrating an exemplary method 1500 for transferring funds to EGM 908 using gaming system 900, for example, by executing wallet transfer orchestrator 942 (all shown in FIG. 9).

Method 1500 may include determining a session has been established by a user of a plurality of users at EGM 908, which is associated with a CMS 968 or other venue wallet system and a corresponding venue system 902. To determine the session has been established, wallet transfer orchestrator 942 or another component of gaming system 900 may determine, for example, that a user card associated with the user has been entered at the EGM 908 or that a request to establish the session at EGM 908 from a mobile device 904 associated with the user executing mobile application 910.

Method 1500 may further include receiving 1504 a transaction request associated with EGM 908, the transaction request identifying a transaction amount such as a desired amount of credits to load onto EGM 908. The transaction request may be received from, for example, EGM 908 or mobile device 904 executing mobile application 910.

Method 1500 may further include, in response to determining the session has been established and receiving the transaction request, transmitting 1506 instructions to ledger 946 to cause ledger 946 to record a virtual transfer of funds record equal to the transaction amount from a virtual user account 1012 associated with the user to a venue virtual account 1014 within ledger 946.

Method 1500 may further include, in response to receiving a first confirmation from the immutable CL that the virtual transfer of funds record is recorded, transmitting 1508 instructions to venue system 902 to cause CMS 968 or another venue wallet system to initiate a transfer of the transaction amount to a credit balance of EGM 908. For example, a cashless payment system of CMS 968 may transfer funds from the venue gaming account 1016 to EGM 908. In some embodiments, a second confirmation may be received from CMS 968 that the transaction amount is transferred to the credit balance of the gaming device. The first confirmation and second confirmation may be stored in wallet database 944 (e.g., within transfer status table 1006). The transmission of these instructions and confirmations between wallet transfer orchestrator 942 and CMS 968 may be handled by message broker 954.

Method 1500 may further include determining 1510 the session has ended. For example, to determine the session has ended wallet transfer orchestrator 942 or another component of gaming system 900 may determine the session has ended by determining a user card associated with the user has been removed at EGM 908, by receiving a request to end the session at EGM 908 from mobile device 904 executing mobile application 910, or by determining a mobile device associated with the user is not detected by a wireless beacon of EGM 908.

Method 1500 may further include receiving 1512, from CMS 968, a remaining credit balance amount that has been transferred from EGM 908 to venue gaming account 1016e, and, in response to determining the session has ended, transmitting 1514 instructions to ledger 946 to cause ledger 946 to record a second virtual funds transfer of funds record equal to the remaining credit balance from venue virtual account 1014 to virtual user account 1012 within the immutable CL.

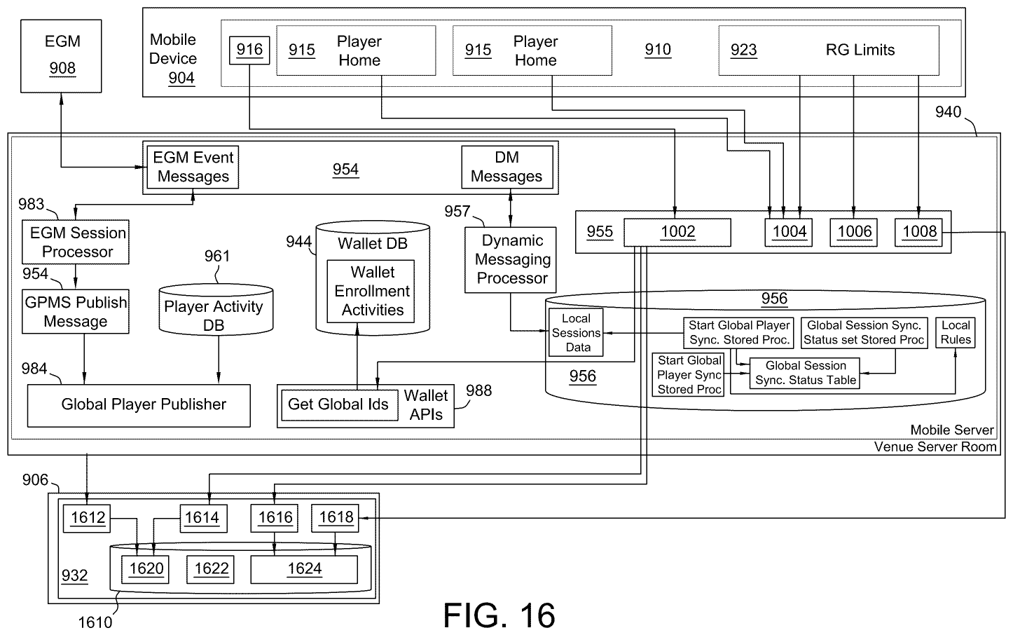

FIG. 16 is a diagram of gaming system 900 illustrating additional example details for synchronizing global RG rules and RG metrics across multiple venues. Gaming system 900 may publish RG rules and data from a venue system 902 into global player management services 932, and may pull down those rules and data from global player management services 932 to different venue systems 902 and synchronize into within the corresponding local dynamic messaging database 956.

As shown in FIG. 16, dynamic messaging module 955 may include a synchronize global player data and rules API 1602, a verify limits API 1604, a get limits API 1606, and an update limits API 1608. Synchronize global player data and rules API 1602 may be in communication with mobile device 904, global player management services 932, dynamic messaging database 956, and wallet APIs 988, and may facilitate synchronizing activity and rules (e.g., RG limits) stored in dynamic messaging database 956 with those stored by global player management services 932 and other dynamic messaging databases 956 (e.g., of other venue systems 902) via global player management services 932, and to forward any updates or changes made to activity or rules locally at dynamic messaging database 956 so these changes can also be made at global player management services 932 and dynamic messaging databases 956 of other venue systems 902. Verify limits API 1604 may be in communication with mobile device 904 and dynamic messaging database 956, and may enable mobile application 910 to verify any desired transaction input via mobile device 904 does not violate any rules or limits dynamic messaging database 956. Get limits API 1606 may be in communication with mobile device 904 and dynamic messaging database 956, and may enable mobile application to retrieve and display any rules or limits stored in dynamic messaging database 956. Update limits API 1608 may be in communication with mobile device 904 and dynamic messaging database 956, and may enable rules or limits stored in dynamic messaging database 956 to be updated via mobile application 910.

Global player management services 932 may include a global customer database 1610, a record session summary API 1612, a get RG data API 1614, a get global RG rules API 1616, and an update global RG rules API 1618. Global customer database 1610 may store a session summary table 1620, a venue table 1622, and global RG rules 1624. Session summary table 1620 may include player activity across all connected venues, which may be compared to global RG rules 1624 to ensure a user is compliant based on activity across all of these venues. In some cases, each user or user-venue combination may have their own associated global RG rules 1624. Record session summary API 1612 may be in communication with global player publishers 984 of corresponding venue systems 902, and may enable recording of activity across all connected venue systems 902 in session summary table 1620. Get RG data API 1614 and a get global RG rules API 1616 may be in communication with synchronize global player data and rules API 1602 to update data stored in global customer database 1610 based on data received from different venue systems 902 and distribute data to these different venue systems 902 to be updated locally. Update global RG rules API 1618 may be in communication with update limits API 1608, and may record at global RG rules 1624 any changes made to RG limits locally at a venue system 902.

Dynamic messaging listener 957 may be notified whenever a user starts a session on an EGM 908. When the member exceeds a configured RG limit stored, for example, at dynamic messaging database 956, dynamic messaging listener 957 may send a push notification message to mobile application 910. If the corresponding user is currently in a mobile session, a pop-up message may be shown on mobile application 910, and mobile application 910 can then end the current mobile session.

EGM session processor 983 may be configured to pick a number of messages transmitted using message broker 954 off the queue and calling stored procedures in wallet database 944. EGM session processor 983 may listening for session information regardless of how the session started (e.g., anonymous play, player card, wallet/mobile device). Mobile application 910 can integrate global player management services 932, to retrieve global RG rules 1624 and session data stored in session summary table 1620 and store this into the local venue-specific dynamic messaging database 956. Dynamic messaging module 955 may publish session summary data to global player management services 932. By doing so, gaming system 900 can combine/tie sessions together to detect RG events or anti-money laundering events using AML across multiple different venues.

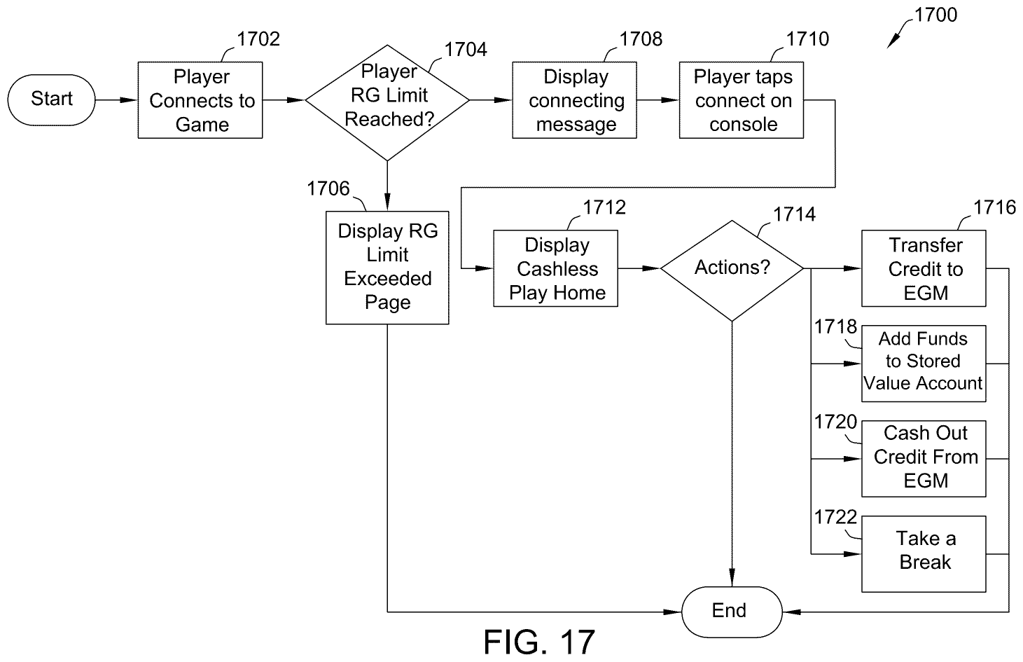

FIG. 17 is a flowchart 1700 illustrating an example RG check operation when connecting to an electronic game. Specifically, connecting to a game for cashless play enables the user to connect using Bluetooth, have any RG limits checked and, if the user is compliant with the RG limits, the user can play with digital funds from the universal wallet where they can transfer credit to the EGM 908, see statistics about the session and cash out from EGM 908 and end the session.

A user may connect to a game, for example, at EGM 908 (block 1702). Gaming system 900 may determine if the user has locally and/or globally exceeded any RG limits (block 1704). If the user has exceeded these limits, EGM 908 and/or mobile application 910 may display an RG limit exceeded page and no session may be established (block 1706). If the user has not exceeded these limits EGM 908 and/or mobile application 910 may display a connecting message (block 1708) and enable the player to tap a connect option (block 1710), which results in a displaying a cashless pay home page (block 1712). Through the cashless pay home page, the user may select from a list of actions (block 1714), which may include transferring or topping up credit to EGM 908 (block 1716), adding funds to the stored value account (block 1718), cashing out credit from EGM 908 (block 1720), and take a break or end the session (block 1722).

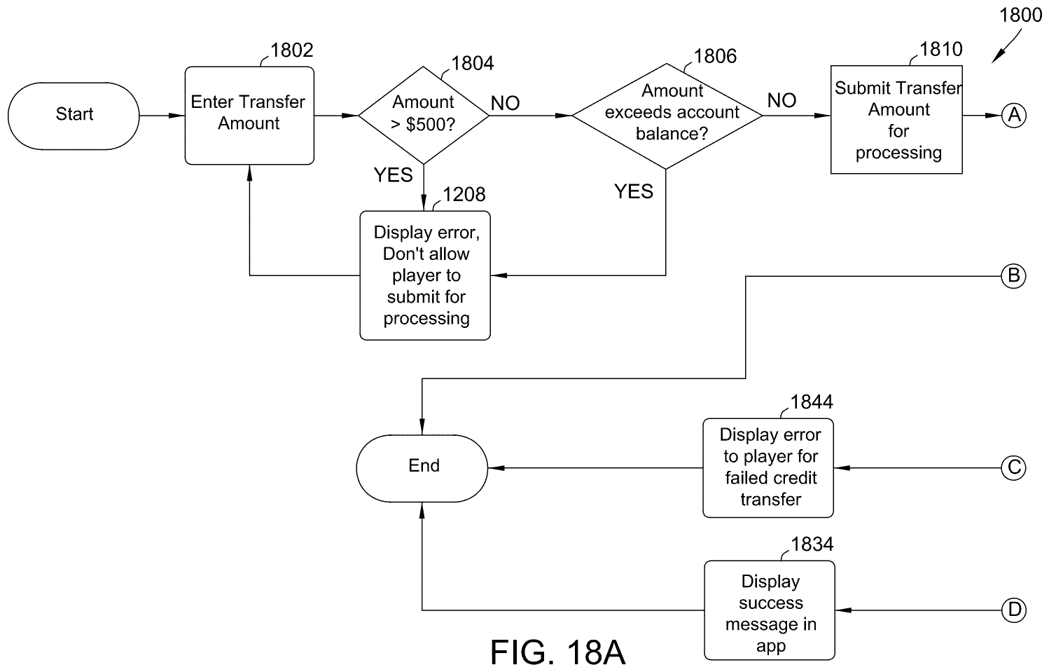

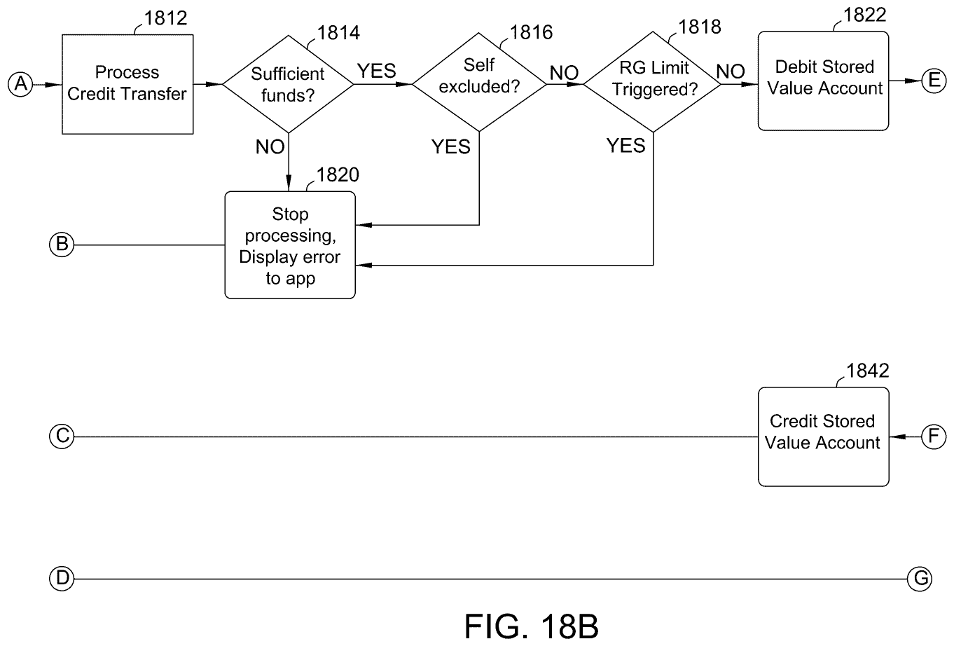

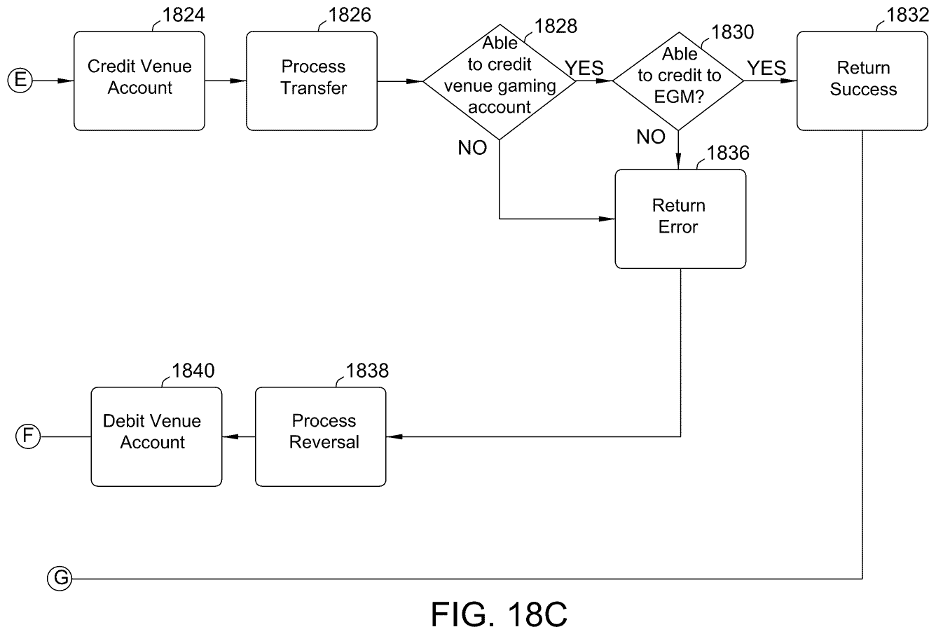

FIGS. 18A, 18B, and 18C depict a flowchart 1800 illustrating an example RG check operation when transferring funds from an external bank account to the digital wallet system (e.g., user's virtual account) and on to an EGM 908. Specifically, the user can transfer or add credit when connected to a session at EGM 908.

A user may enter an amount to transfer to the digital wallet account via EGM 908 or mobile application 910 (block 1802). Gaming system 900 may determine if the amount exceeds a predefined threshold for transfers (e.g., 500 dollars) (block 1804) and if the amount exceeds the user's account balance (block 1806). If either of these amounts are exceeded, an error message may be displayed and the request is not submitted for processing (block 1808). If these amounts are not exceeded, the request may be submitted for processing (block 1810) and gaming system 900 may process the request (block 1812). UPS may determine if there are sufficient funds (block 1814), if the player is not on a self-exclusion list (block 1816), and if RG limits have not been exceeded (block 1818). If any of these conditions are failed, a corresponding error message may be displayed and gaming system 900 may cease processing the request (block 1820). If these conditions are all met, gaming system 900 may debit the user's account (block 1822), credit the appropriate venue account (block 1824), and process the transfer to EGM 908 (block 18226). If gaming system 900 is successfully able to credit the venue account (block 1828) and EGM 908 (block 1830), a success message may be returned by gaming system 900 (block 1832) and displayed by mobile application 910 (block 1834). If these credits are unsuccessful, gaming system 900 may return an error message (block 1836), reverse the credits to EGM 908 (block 1838), venue account (block 1840), and stored value account (block 1842), and display an error message (block 1844).

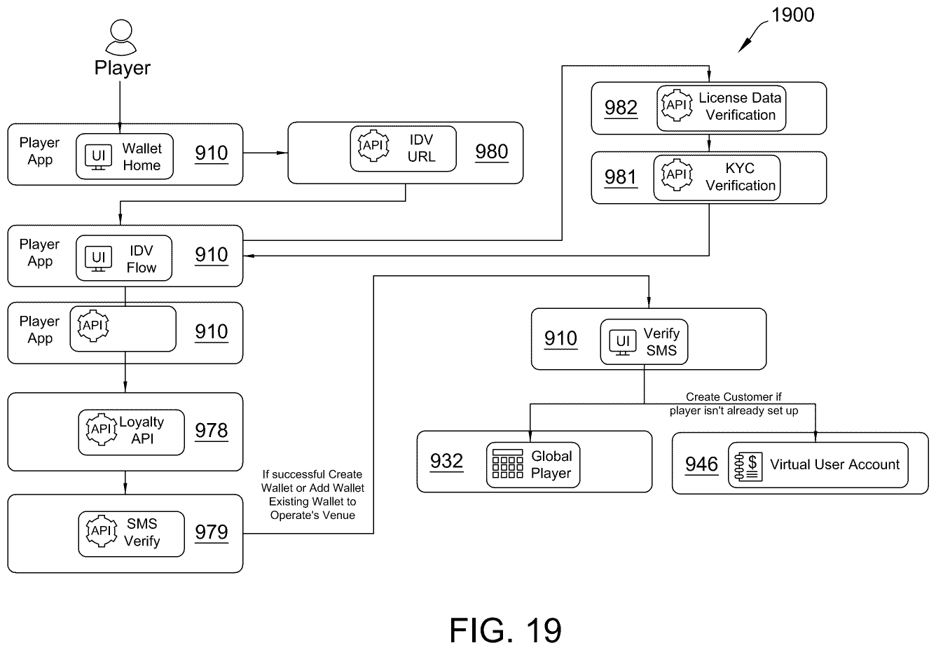

FIG. 19 is a data flow diagram 1900 illustrating an example identification verification process while a user is enrolling with gaming system 900. The user may enter identification data using mobile application 910, and mobile application 910 may query identity verification server 980, KYC verification 981 (e.g., watchlists), license data verification 982 (e.g., government databases), a loyalty database 978, and message verification 979 to verify that the user's purported identity is accurate. Mobile application 910 may then notify global player management services 932 and ledger 946 that the user has been successfully authenticated so that the user can be enrolled.

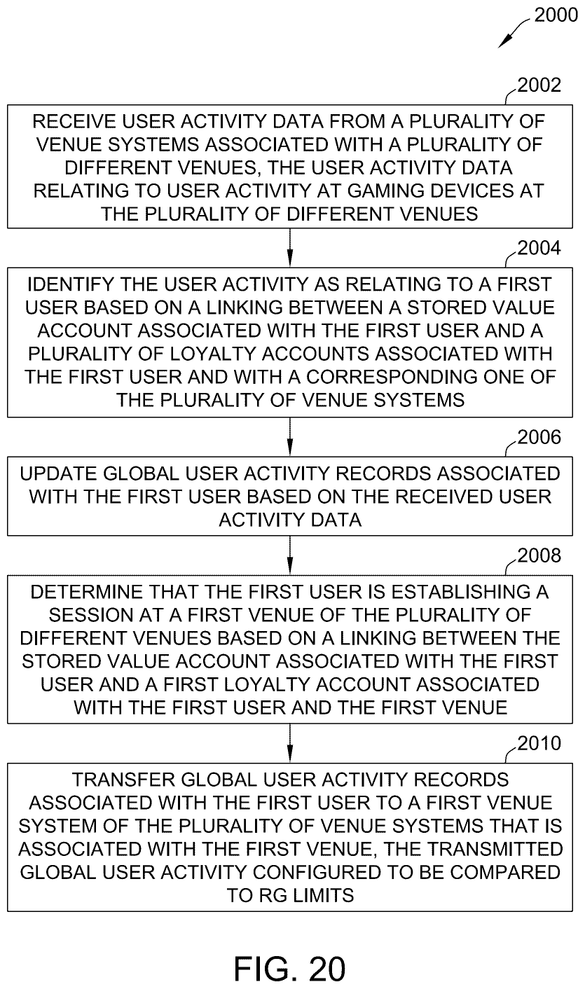

FIG. 20 is a flowchart illustrating an exemplary method 2000 for global player management using gaming system 900 (shown in FIGS. 9 and 10). Method 2000 may be performed, for example, by global player management services 932 and/or other components of gaming system 900.

Method 2000 may include receiving 2002 user activity data from a plurality of venue systems 902 associated with a plurality of different venues. The user activity data may relate to user activity at EGMs 908 at the plurality of different venues.

Method 2000 may further include identifying 2004 the user activity as relating to a first user based on a linking between the stored value account associated with the first user and a plurality of loyalty accounts associated with the first user and with a corresponding one of the plurality of venue systems 902.

Method 2000 may further include updating 2006 global user activity records associated with the first user stored in global customer database 1610 based on the received user activity data.

Method 2000 may further include determining 2008 that the first user is establishing a session at a first venue of the plurality of different venues based on a linking between the stored value account associated with the first user and a first loyalty account associated with the first user and the first venue.

Method 2000 may further include transmitting 2010 global user activity records associated with the first user to a venue system 902 that is associated with the first venue. The transmitted global user activity records configured to be compared to the RG limits, for example, to ensure that the first user's activity complies with the limits and take measures (e.g., preventing transfers of funds and/or ending the session) if the user's activity across the different venues has exceeded the RG limits.

In some embodiments, global player management services 932 may receive an update to the RG limits associated with the user from a mobile device 904 associated with the user executing mobile application 910, and based on this update, may update the RG limits stored in the global customer database. Global player management services 932 may then transmit the updated RG limits to the plurality of venue systems, enabling each venue system 902 to enforce the updated RG limits.

In some embodiments, venue system 902 may be configured to, when receiving a transaction request associated with a user (e.g., a request to load digital wallet funds onto EGM 908), determine to execute the transaction request based on a comparison between the updated local user activity records associated with the user and RG limits associated with the user. For example, if the user has exceeded the RG limits, venue system 902 may prevent the transaction from being executed. The transaction request may be received, for example, from EGM 908 or from mobile device 904 executing mobile application 910, and may identify a transaction amount to transfer to the at least one gaming device from a stored value account associated with the user and defined in ledger 946.

In some embodiments, venue systems 902 may be further configured to end an active session at EGM 908 associated with the user in response to a determination that the RG limits associated with the user are exceeded based on the updated local user activity records. For example, venue systems 902 may transmit instructions to EGM 908 causing the user to be logged out, automatically cashed out, and/or prevented from engaging in further gameplay. Venues systems 902 may cause the at least one gaming device to display a notification in response to a determination that the RG limits associated with the user are exceeded based on the updated local user activity records.

In some embodiments, the global user activity records are each further associated with a jurisdiction of a plurality of jurisdictions, and the RG limits are configured to be applied based on activity within the associated jurisdiction. In other words, global player management services 932 can be configured to have a single player database record within a certain country or other jurisdictional boundary to satisfy local gaming regulations.

In some embodiments, global player management services 932 may be configured to receive, from a second venue system 902, a request to link the stored value account associated with the first user to a second loyalty account associated with a second venue associated with the second venue system, the request including identification information associated with the first user. This identification information may be input by the first player via mobile application and/or retrieved from authentication system 974, identity verification server 980, or other sources in communication with venue system 902, as describe above. Global player management services 932 may identify the stored value account associated with the first user based on the identification information associated with the first user, and in response to identifying the stored value account associated with the first user, may record a linking between the stored value account and the second loyalty account.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A computer system comprising at least one processor in communication with at least one memory device, with a casino management system (CMS) that is associated with a venue gaming account, and with an immutable CL that is associated with a system account that stores actual funds, the immutable CL including a venue virtual account and multiple virtual user accounts for a stored value account of a user, the at least one processor configured to execute instructions which, when executed by the at least one processor, cause the at least one processor to:
determine a session has been established by the user at a gaming device associated with the CMS;
receive a transaction request associated with the gaming device, the transaction request identifying a transaction amount;
in response to determining the session has been established and receiving the transaction request, transmit instructions to the immutable CL to cause the immutable CL to record a virtual transfer of funds record equal to the transaction amount from a virtual user account associated with the user to the venue virtual account; and
in response to receiving a first confirmation from the immutable CL that the virtual transfer of funds record is recorded, transmit instructions to a venue system to cause the CMS to initiate a transfer of the transaction amount from the venue gaming account to a credit balance of the gaming device.

2. The computer system of claim 1, further comprising a message broker in communication with the at least one processor and with the CMS, wherein the instructions further cause the at least one processor to transmit the instructions to cause the CMS to transfer the transaction amount through the message broker.

3. The computer system of claim 2, further comprising a wallet database in communication with the at least one processor, wherein the instructions further cause the at least one processor to:
receive, through the message broker, a second confirmation from the CMS that the transaction amount is transferred to the credit balance of the gaming device; and
store the second confirmation in the wallet database.

4. The computer system of claim 3, wherein the instructions further cause the at least one processor to store the first confirmation in the wallet database.

5. The computer system of claim 1, wherein the instructions further cause the at least one processor to determine the session has been established by determining a user card associated with the user has been entered at the gaming device.

6. The computer system of claim 1, wherein the instructions further cause the at least one processor to determine the session has been established by receiving a request to establish the session at the gaming device from a mobile device associated with the user.

7. The computer system of claim 1, wherein the transaction request is received from the gaming device.

8. The computer system of claim 1, wherein the transaction request is received from a mobile device associated with the user.

9. The computer system of claim 1, wherein the instructions further cause the processor to:
determine the session has ended;
receive, from the CMS, a remaining credit balance amount that has been transferred from the gaming device to the venue gaming account; and
in response to determining the session has ended, transmit instructions to the immutable CL to cause the immutable CL to record a second virtual transfer of funds record equal to the remaining credit balance from the venue virtual account to the virtual user account within the immutable CL.

10. The computer system of claim 9, wherein the instructions further cause the processor to determine the session has ended by determining a user card associated with the user has been removed at the gaming device.

11. The computer system of claim 9, wherein the instructions further cause the processor to determine the session has ended by receiving a request to end the session at the gaming device from a mobile device associated with the user.

12. The computer system of claim 9, wherein the instructions further cause the processor to determine the session has ended by determining a mobile device associated with the user is not detected by a wireless beacon of the gaming device.

13. A method performed by at least one processor in communication with at least one memory device, with a venue wallet system that is associated with a venue gaming account, and with an immutable CL that is associated with a system account that stores actual funds, the immutable CL including a venue virtual account and multiple virtual user accounts for a stored value account of a user, the method comprising:
determining a session has been established by the users at a gaming device associated with the venue wallet system;
receiving a transaction request associated with the gaming device, the transaction request identifying a transaction amount;
in response to determining the session has been established and receiving the transaction request, transmitting instructions to the immutable CL to cause the immutable CL to record a virtual transfer of funds record equal to the transaction amount from a virtual user account associated with the user to the venue virtual account; and
in response to receiving a first confirmation from the immutable CL that the virtual transfer of funds record is recorded, transmitting instructions to a venue system to cause the venue wallet system to initiate a transfer of the transaction amount from the venue gaming account to a credit balance of the gaming device.

14. The method of claim 13, further comprising transmitting the instructions to cause the venue wallet system to transfer the transaction amount through a message broker.

15. The method of claim 14, further comprising:
receiving, through the message broker, a second confirmation from the venue wallet system that the transaction amount is transferred to the credit balance of the gaming device; and
storing the second confirmation in a wallet database.

16. The method of claim 15, further comprising storing the first confirmation in the wallet database.

17. The method of claim 10, further comprising:
determining the session has ended;
receiving, from the venue wallet system, a remaining credit balance amount that has been transferred from the gaming device to the venue gaming account; and
in response to determining the session has ended, transmitting instructions to the immutable CL to cause the immutable CL to record a second virtual transfer of funds record equal to the remaining credit balance from the venue virtual account to the virtual user account within the immutable CL.

18. At least one non-transitory computer-readable storage media having instructions embodied thereon, wherein when executed by at least one processor in communication with at least one memory device, with a casino management system (CMS) that is associated with and a venue gaming account, and with an immutable CL that is associated with a system account that stores actual funds, the immutable CL including a venue virtual account and multiple virtual user accounts for a stored value account of a user, the instructions cause the at least one processor to:
determine a session has been established by the user at a gaming device associated with the CMS;
receive a transaction request associated with the gaming device, the transaction request identifying a transaction amount;
in response to determining the session has been established and receiving the transaction request, transmit instructions to the immutable CL to cause the immutable CL to record a virtual transfer of funds record equal to the transaction amount from a virtual user account associated with the user to the venue virtual account; and
in response to receiving a first confirmation from the immutable CL that the virtual transfer of funds record is recorded, transmit instructions to a venue system to cause the CMS to initiate a transfer of the transaction amount from the venue gaming account to a credit balance of the gaming device.

19. The at least one non-transitory computer-readable storage media of claim 18, wherein the instructions further cause the at least one processor to:
receive, through a message broker, a second confirmation from the CMS that the transaction amount is transferred to the credit balance of the gaming device; and
store the second confirmation in a wallet database.

20. The at least one non-transitory computer-readable storage media of claim 19, wherein the instructions further cause the at least one processor to store the first confirmation in the wallet database.
